(19) United States
(12) Patent Application Publication
(10) Pub. No.: US 2026/0319603 A1
(43) Pub. Date: Oct. 15, 2026

(54) SYSTEMS AND METHODS FOR CONTROLLING A SEQUENTIAL WORKFLOW

(71) Applicant: INTUITIVE SURGICAL OPERATIONS, INC., Sunnyvale, CA (US)

(72) Inventors: Ryan C. Abbott, San Jose, CA (US); Heath Corbet, Campbell, CA (US)

(21) Appl. No.: 19/651,415

(22) Filed: Apr. 17, 2026

Related U.S. Application Data
(63) Continuation of application No. PCT/US2024/051362, filed on Oct. 15, 2024.
(63) Continuation of application No. PCT/US2024/051412, filed on Oct. 15, 2024.
(60) Provisional application No. 63/591,537, filed on Oct. 19, 2023.
(60) Provisional application No. 63/591,591, filed on Oct. 19, 2023.

(51) Int. Cl. G06F 3/0362; G06F 3/01

(52) U.S. Cl. CPC G06F 3/0362; G06F 3/016

(57) ABSTRACT

A manual user interface system comprises a knob movable in at least one rotational degree of freedom and at least one translational degree of freedom and an actuator system coupled to the knob and responsive to a plurality of movements of the knob to operate a plurality of instrument devices of a robotically-assisted instrument system through a plurality of predetermined stages of a sequential workflow.

### CROSSED-REFERENCED APPLICATIONS

This application claims priority to and benefit of U.S. Provisional Application No. 63/591,537 filed Oct. 19, 2023 and entitled “Systems and Methods for Controlling a Sequential Workflow,” which is incorporated by reference herein in its entirety. This patent application is also related to U.S. Provisional Application No. 63/591,591, entitled “Systems and Methods for Actuating an Instrument System,” filed Oct. 19, 2023, which is incorporated by reference herein in its entirety. This patent application is also related to International Application No. PCT/US2024/0[Docket No. P06766-WO2], entitled “Systems and Methods for Actuating an Instrument System,” filed Oct. 15, 2024, which is incorporated by reference herein in its entirety.

### FIELD

Examples described herein relate to systems and methods for controlling a sequential workflow. More particularly, examples may relate to the use of a multiple degree of freedom user interface device that actuates multiple functions of an instrument system during a sequential workflow of a medical procedure.

### BACKGROUND

Minimally invasive medical techniques may generally be intended to reduce the amount of tissue that is damaged during medical procedures, thereby reducing patient recovery time, discomfort, and harmful side effects. Such minimally invasive techniques may be performed through natural orifices in a patient anatomy or through one or more surgical incisions. Through these natural orifices or incisions an operator may insert minimally invasive medical instruments such as therapeutic instruments, diagnostic instruments, imaging instruments, and surgical instruments. Some minimally invasive medical instrument systems may be controlled using multiple user input devices and may require multiple hands or multiple operators to actuate. Systems and methods are needed to reduce the complexity of the user inputs needed to perform a medical procedure.

### SUMMARY

The following presents a simplified summary of various examples described herein and is not intended to identify key or critical elements or to delineate the scope of the claims.

In some examples, a manual user interface system comprises a knob movable in at least one rotational degree of freedom and at least one translational degree of freedom and an actuator system coupled to the knob and responsive to a plurality of movements of the knob to operate a plurality of instrument devices of a robotically-assisted instrument system through a plurality of predetermined stages of a sequential workflow.

In some examples, a manual user interface system comprises a knob movable in at least one rotational degree of freedom and an actuator system coupled to the knob and responsive to rotation of the knob in a first direction of the rotational degree of freedom to operate a device of a robotically-assisted instrument system through a forward sequence of stages of a workflow and responsive to rotation of the knob in a second direction of the rotational degree of freedom to operate the device through a reverse sequence of stages of the workflow.

In some examples, a method comprises receiving a first user input at a manual user interface. The manual user interface is movable in a plurality of degrees of freedom. The method also comprises responsive to the first user input at the manual user interface, moving a first instrument device of a robotically-assisted instrument system in a first predetermined stage of a sequential workflow and receiving a trigger associated with an end of the first predetermined stage of the sequential workflow. The method also comprises receiving a second user input at the manual user interface, and responsive to the second user input, moving a second instrument device of the robotically-assisted instrument system in a second predetermined stage of the sequential workflow.

In some examples, a method comprises receiving a first user input in a first user interface degree of freedom at a manual user interface to cause a first instrument device to take a first action and receiving a second user input in a second user interface degree of freedom at the manual user interface to cause a second instrument device to take a second action. The method also comprises receiving a third user input in the first user interface degree of freedom at the manual user interface to cause the second instrument device to take a third action.

In some examples, a method comprises receiving a first user input in a first user interface degree of freedom at a manual user interface to cause a first instrument device to take a first action and receiving a second user input in the first user interface degree of freedom at the manual user interface to cause a second instrument device to take a second action. The method also comprises receiving a third user input in the first user interface degree of freedom at the manual user interface to cause the second instrument device to take a third action.

It is to be understood that both the foregoing general description and the following detailed description are illustrative and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTIONS OF THE DRAWINGS

FIGS. 1A and 1B illustrate a manual user interface system, according to some examples.

FIG. 2 illustrates a distal portion of an instrument system for creating a suture pattern, according to some examples.

FIG. 3A illustrates an operator input system including a manual user interface system, according to some examples.

FIG. 3B illustrates an operator input system including a manual user interface system, according to some examples.

FIG. 3C illustrates an operator input system including a manual user interface system, according to some examples.

FIG. 4 is a flowchart illustrating a method for controlling an instrument system, according to some examples.

FIG. 5 is a flowchart illustrating predetermined stages in a sequential workflow for a suturing procedure that may be performed with an instrument system, according to some examples.

FIG. 6 is a flowchart illustrating a method for controlling an instrument system with a single manual user interface device that moves or responds to forces in multiple degrees of freedom, according to some examples.

FIG. 7 is a flowchart illustrating a method for controlling an instrument system with a single manual user interface device that moves or responds to forces in a single degree of freedom, according to some examples.

FIG. 8A illustrates a graphical user interface displayed on a display screen of a manual user interface device, according to some examples.

FIG. 8B illustrates a control panel including a manual user interface device and a display screen, according to some examples.

FIG. 8C illustrates a graphical user interface that may be displayed on a display screen, according to some examples.

FIG. 8D illustrates the graphical user interface including virtual features that provide a virtual representation of instrument system components that may be obscured by tissue in the field of view of an imaging system, according to some examples.

FIG. 8E illustrates a graphical user interface that may be displayed on a display screen, according to some examples.

FIG. 9A illustrates an instrument actuation system that may be used to actuate one or more instrument devices of an instrument system, according to some examples.

FIG. 9B illustrates an opposite side of the instrument actuation apparatus of FIG. 9A.

FIG. 9C illustrates a detailed portion of an actuation mechanism of FIG. 9A.

FIG. 10 illustrates an instrument actuation apparatus coupled to an instrument system, according to some examples.

FIG. 11 is a simplified diagram of a patient anatomy, according to some examples.

FIG. 12 is a schematic diagram for a robotically-assisted manipulator system, according to some examples.

FIG. 13A is a schematic diagram of an instrument system according to examples.

FIG. 13B illustrates a distal portion of the instrument system of FIG. 13A with an extended example of an instrument according to examples.

FIG. 14 schematically illustrates an instrument actuation system that may be used to actuate one or more instrument devices of an instrument system, according to some examples.

FIG. 15A illustrates an instrument actuation system that may be used to actuate one or more instrument devices of an instrument system, according to some examples.

FIG. 15B illustrates an opposite side of the instrument actuation apparatus of FIG. 15A.

FIG. 16A illustrates an operator operating an instrument to which an instrument actuation apparatus is coupled, according to some examples.

FIG. 16B illustrates a remote manual user interface device according to some examples.

FIG. 17 illustrates a remote manual user interface device according to some examples.

FIG. 18A illustrates an instrument actuation system that may be used to actuate one or more instrument devices of an instrument system, according to some examples.

FIG. 18B illustrates an opposite side of the instrument actuation apparatus of FIG. 18A.

Examples of the present disclosure and their advantages are best understood by referring to the detailed description that follows. It should be appreciated that like reference numerals are used to identify like elements illustrated in one or more of the figures, wherein showings therein are for purposes of illustrating examples of the present disclosure and not for purposes of limiting the same.

### DETAILED DESCRIPTION

The technology described herein provides endoscopic techniques and treatment systems that utilize a multiple degree of freedom, manual user interface device. The techniques and treatment systems may be used to perform medical procedures such as, surgery, biopsy, suturing, ablation, illumination, irrigation, or suction. Some procedures may be performed in the upper or lower gastrointestinal track including, for example fistula closure, endoscopic submucosal dissections, endoscopic mucosal resections, peroral endoscopic myotomy, endoscopic sleeve gastroplasty, and/or transoral outlet reduction endoscopy. Although the examples provided herein may be used for suturing of gastrointestinal tissue, it is understood that the described technology may be used in performing procedures in artificially created lumens or any endoluminal passageway or cavity, including in a patient trachea, colon, intestines, stomach, liver, kidneys and kidney calices, brain, heart, circulatory system including vasculature, fistulas, and/or the like.

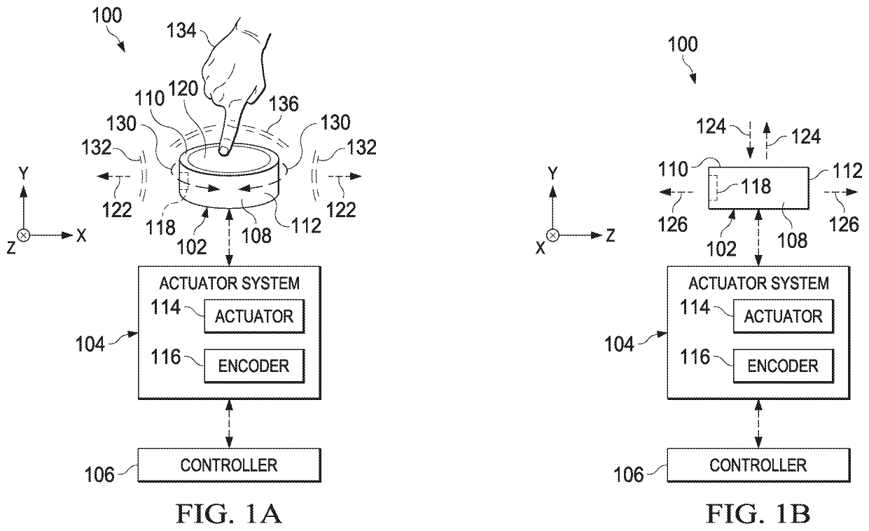

FIG. 1A illustrates a perspective view and FIG. 1B illustrates a side view of a manual user interface system 100 including a single manual user interface device such as knob 102 that may be actuated with a single hand of a user to operate multiple actions of an instrument system. The knob 102 may include a body 108 with a round, cylindrical, spherical, domed, mushroom, or other shape that may accommodate interaction with a human hand. The knob may, for example, be sized to fit within a space formed by the fingers of a human hand. The knob body 108 may include an upper surface 110 and a side surface 112. The manual user interface system 100 may also include an actuator system 104 and a controller 106. The actuator system 104 may be coupled to the knob body 108 and may include an actuator 114 such a brushless DC motor or a brushed DC motor. The actuator system 104 may also include an encoder 116. Data from the encoder 116 may drive motion of an instrument system (e.g. the instrument system 200) through one or more operations, actions, or functions. The controller 106 may be in communication with the actuator system 104 and may communicate with an instrument actuation apparatus (i.e., the instrument actuation apparatus 802). The controller 106 may be, for example, an Arduino-based controller, microcontroller, computer, or other computing device. In some examples, the knob 102 may include a display screen 120 that may include a touchscreen to receive user input via touch gesture from one or more fingers. The touchscreen may include, for example, a resistive touch panel, a capacitive touch panel, an infrared touch panel, a surface acoustical wave touch panel, or an optical imaging touch panel. The touchscreen may be used to operate a secondary instrument system such as an imaging system. In some examples, the manual user interface system 100 may be a control device of an operator input system (e.g., operator input system 1106) and the controller 106 may be a component of a control system (e.g., control system 1112) of a robotically-assisted medical system (e.g., medical system 1100).

The knob 102 may be movable in multiple degrees of freedom in response to input from a user. For example, the knob may move in translation 122 in + and/or −X directions (e.g., right and left), move in translation 124 in + and/or −Y directions (e.g., up and down), and/or move in translation 126 in + and/or −Z directions (e.g., forward and backward). The knob 102 may provide spring-loaded or haptic-force button action to return the knob to a central position after a translation input is received. Additionally or alternatively, the knob 102 may move in rotation 130 in clockwise or counter-clockwise directions. In some examples, the knob 102 may include one or more force sensors 118 that may detect and respond to forces 132 or pressure applied simultaneously to the side surface 112 (e.g. simultaneously in the +/−X direction), such as forces associated with a squeeze or grasping action at the knob 102. In some examples, the knob 102 may include the display screen 120 which may include a touchscreen to receive user input via a touch gesture 134 from one or more fingers. The touchscreen may include, for example, a resistive touch panel, a capacitive touch panel, an infrared touch panel, a surface acoustical wave touch panel, or an optical imaging touch panel. In some examples, the knob 102 may provide haptic output 136 such as vibrations or rotational detents (e.g., a clicking sensation).

The knob 102 may be used to control several instrument devices of an instrument system, with the particular instrument device under control dependent upon the current stage of a predetermined workflow, as described below. In various examples, the motions or degrees of freedom of motion of the knob 102 may be omitted or locked to constrain available motion inputs or outputs. The constraints may be based, for example, on the instrument device currently being controlled or the current stage of a sequential workflow. For some procedures or for some controlled instrument devices, for example, the knob 102 may be constrained to bi-directional rotation and translation motion in the +/−Y direction. For some procedures, specific instruments, specific functions of instruments, or specific degrees of freedom of motion may be omitted, constrained, or restricted. In various examples, a combined motion may be implemented based on a user input. For example, the knob may be moved in a translation degree of freedom while also being squeezed to cause translational motion of a robotically-assisted instrument device while an end effector of the instrument is grasping tissue.

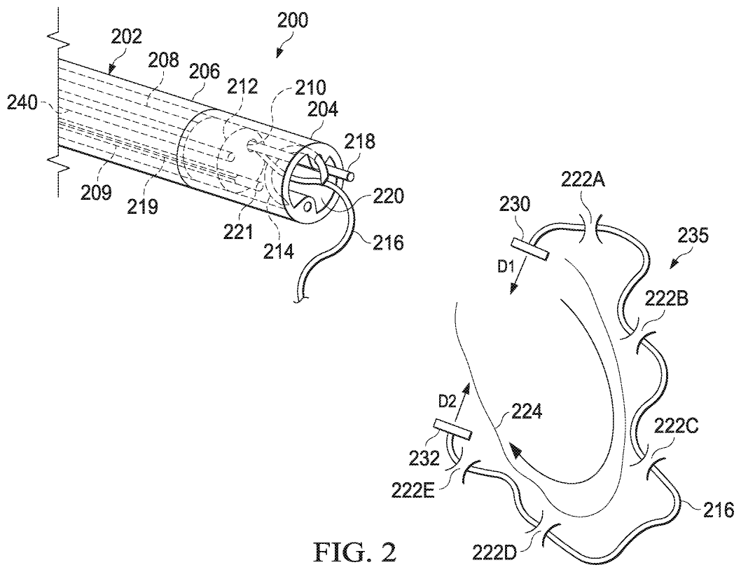

Any of a variety of instrument systems may be operated by robotic-assistance in response to user inputs at the manual user interface system 100. Instrument systems may include suture, biopsy, ablation, imaging, treatment delivery, or other instrument systems used in a medical procedure. FIG. 2 illustrates a distal portion of an instrument system 200 that may be operated by robotic-assistance in response to user inputs at the manual user interface system 100 to perform a suturing procedure. The instrument system 200 may include an elongate device 202 and a suture apparatus 204. In some examples, the instrument system 200 may be an endoscopic instrument system and the elongate device 202 may be a flexible, steerable endoscope. The elongate device 202 may serve as a platform to drive motion of mechanisms in the suturing apparatus 204, deliver working components to the anatomic structures accessed by the instrument system 200, and capture image data of the anatomic structures. The device 202 may include a flexible body 206 through which extends one or more working channels 208, 209. The working channels 208, 209 may extend through the flexible body 206 to provide passage for removable instrument systems, suture material, and/or termination members and to allow instruments to be exchanged during a procedure. In some examples, a suture support tool such as a tissue apposition tool 218 may be removably extendable within the working channel 208, and a suture support tool such as a needle exchange tool 219 may be removably extendable within the working channel. A needle tip capture mechanism 221 may be disposed at the end of the needle exchange tool 219 and may be operated independently of the insertion and retraction motion of the needle exchange tool 219. The tissue apposition tool 218 and the needle exchange tool 219 may be removable and various other suture support tools may be extended in the working channels. In some examples, the tissue apposition tool 218 may include a helical shaped component that may be rotated into tissue engagement. In other examples, the apposition tool may include opposed jaws, clamps, or other tissue grasping mechanisms to engage tissue and move tissue. Other suture support tools may include, for example, a tissue apposition tool sheath, a suture tensioning tool, a termination member transfer tool, a cinching tool, a needle tip exchange tool, or other tool for use during a portion of a suturing procedure. The working channels 208, 209 may also or alternatively allow fluid passage, deliver vacuum pressure, or otherwise provide access between proximal and distal portions of the elongate flexible device 202. Each working channel may terminate at an opening in a distal end portion 212 of the device 202. For example, the working channel 208 may terminate at an opening 210.

The suture apparatus 204 may include a suture needle 214 which may be coupled to a suture strand 216 or other type of natural or synthetic suture material. The suture strand 216 may be coupled to the suture needle 214. The suture needle 214 may be straight, arc-shaped, semi-circular, or another suitable shape for capturing a suture bite. The suture needle 214 may include a needle arm and at least one end portion with a pointed tip configured to pierce tissue. The suture apparatus 204 may also include a tissue apposition chamber 220 into which tissue may be drawn in a folded, bended, pinched, or otherwise apposite configuration. In some examples, the suture needle 214 may move along a linear path. In some examples, the suture needle 214 may move from a staging position along an arcuate path in a single direction and return to the staging position. In some examples, the suture needle 214 may move in a bi-directional arcuate path. Optionally, an imaging system 240 may also extend through the flexible body 206 (e.g., imaging system 1109 or a component thereof). The imaging system 240 may be an integrated component of the device 202 (e.g., permanently coupled) or may be slidably received within and removable from the flexible body 206. In some examples, the imaging system 240 may be extended, articulated, steered, or otherwise moved relative to the flexible body 206. In some examples, the imaging system 240 may transmit images using one or more flexible optical fibers. Digital image-based imaging systems may have a “chip on the tip” design in which a distal digital sensor such as a one or more charge-coupled device (CCD) or a complementary metal oxide semiconductor (CMOS) device store image data. The imaging system 240 may capture two- or three-dimensional image data. For example, stereo imaging systems may employ stereo cameras to capture stereo images of the patient anatomy.

The instrument system 200 may be used to perform a suturing procedure that places the suture strand 216 in tissue 224 through a series of suture bites 222A-222E. The sutures bites 222A-222E may form a suture pattern 235. A suture termination member 230 may be coupled to the suture strand 216 proximate to the initial suture bite 222A, and a termination member 232 may be coupled to the suture strand 216 proximate to the final suture bite 222E. The cinching of the suture strand 216 may be accomplished by pulling the strand in either the cinch direction D1 (e.g., away from the initial suture bite 222A as the termination member 230 is moved toward the suture bite 222A) or the cinch direction D2 (e.g., away from the final suture bite 222E as the termination member 232 is moved toward the suture bite 222E). In some examples, the plication may be accomplished by tensioning, at least partially, in both directions D1 and D2. Some aspects of an instrument system and methods of use are described in U.S. Provisional Patent Application No. 63/518,228, titled “Systems and Methods for Endoscopic Tissue Suturing” and filed Aug. 8, 2023, and U.S. Provisional Patent Application No. 63/518,208, titled “Systems and Methods for Endoscopic Tissue Suturing” and filed Aug. 8, 2023, each of which are incorporated by reference herein in their entireties.

The manual user interface system 100 may control actuation of the multiple instrument devices or components of the instrument system. The instrument devices of the instrument system 200, for example, that may be controlled by a manual user interface system may include the suture needle 214, the tissue apposition tool 218, a sheath for the tissue apposition tool 218, a needle tip capture mechanism 221, and/or a needle exchange tool 219. The manual user interface system 100 may, for example, control linear or rotational movement of the suture needle 214. The manual user interface system 100 may also or alternatively control the advancement, retraction, and/or rotation of the apposition tool 218. The manual user interface system 100 may also or alternatively control a grasp and/or release action of a needle tip capture mechanism 221. The manual user interface system 100 may also or alternatively control an advancement and/or retraction of the needle tip exchange tool 219. The manual interface system 100 may also or alternatively control an advancement and/or retraction of a sheath for tissue apposition tool 218. In some examples, the manual user interface 100 may also or alternatively control an advancement, and/or retraction of a cinching tool. In some examples, the manual user interface system 100 may control actuations needed to perform a needle exchange, a suture loading, and/or a suture tensioning procedure.

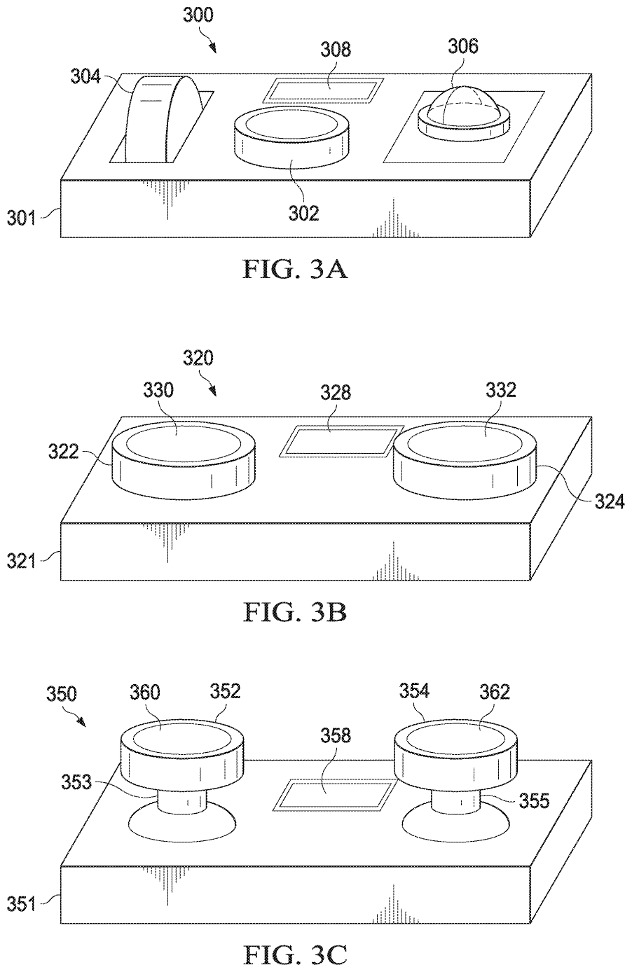

The manual user interface system 100 may be a control device of an operator input system (e.g., operator input system 1106) of a robotically-assisted medical system (e.g., medical system 1100). In some examples, as shown in FIG. 3A, an operator input system 300 may include a control panel 301 to which a manual user interface system 302 is mounted. The manual user interface system 302 may be substantially similar to manual user interface system 100. The control panel 301 may also include a control device 304 and a control device 306. In some examples, the control device 304 may be a scroll wheel and the control device 306 may be a trackball. The control panel 301 may also include a display screen 308 which may display a graphical user interface that optionally includes a touch screen control device. In some examples, the manual user interface system 302 may be used to control actuation of the suture needle 214 and one or more suture support tools such as tissue apposition tool 218 and a cinching tool (not shown). An imaging system may be controlled by the control devices 304 and 306. The imaging system may be the imaging system 240 or may be another endoscopic imaging system coupled to a separate robotically-assisted manipulator. For example, the scroll wheel control device 304 may control insertion/retraction motion of the imaging system 240 and the trackball control device 306 may control steering of the imaging system 240. In alternative examples, the control panel may include other types of control devices to receive a user input and control motion of the imaging system 240. In alternative examples, the manual user interface system 302 may be the only control device mounted to the control panel. In alternative examples, the manual user interface system 302 may be mounted to a control panel with fewer, more, or different user control devices.

In some examples, as shown in FIG. 3B, an operator input system 320 may include a control panel 321 to which a manual user interface system 322 and a manual user interface system 324 is mounted. The manual user interface systems 322, 324 may be substantially similar to manual user interface system 100. The control panel 301 may also include a display screen 328 which may display a graphical user interface that optionally includes a touch screen control device. In this example, the manual user interface system 322 may control actuation of the instrument system 200, and the manual user interface system 324 may control actuation of a different instrument system, such as an instrument system coupled to a different robotically-assisted manipulator, or the manual user interface systems 322, 324 may each control actuation of aspects of a common instrument system 200. An imaging system may be controlled by the touchpad 330 of manual user interface system 322 and the touchpad 332 of manual user interface system 324. The imaging system may be the imaging system 240 or may be another endoscopic imaging system coupled to a separate robotically-assisted manipulator. For example, the touchpad 330 may control insertion/retraction motion of the imaging system and the touchpad 332 may control steering of the imaging system.

In some examples, as shown in FIG. 3C, an operator input system 350 may include a control panel 351 to which a manual user interface system 352 and a manual user interface system 354 is mounted. The manual user interface systems 352, 354 may be substantially similar to manual user interface system 100. In this example, the manual user interface system 352 may be coupled to the panel 351 by a pivot mechanism 353, and the manual user interface system 354 may be coupled to the panel 351 by a pivot mechanism 355. The pivot mechanisms 353, 355 may allow the manual user interface systems 352, 354, respectively, to move in additional or different degrees of freedom. For example, the pivot mechanisms may allow the manual user interface system to pivot in response to user input commands for pitch and yaw steering of instrument devices of instrument system 200. The control panel 301 may also include a display screen 358 which may display a graphical user interface that optionally includes a touch screen control device. In this example, the manual user interface system 352 may control actuation of the instrument system 200, and the manual user interface system 354 may control actuation of a different instrument system, such as an instrument system coupled to a different robotically-assisted manipulator, or the manual user interface systems 352, 354 may each control actuation of aspects of a common instrument system 200. An imaging system may be controlled by the touchpad 360 of manual user interface system 352 and the touchpad 362 of manual user interface system 354. The imaging system may be the imaging system 240 or may be another endoscopic imaging system coupled to a separate robotically-assisted manipulator. For example, the touchpad 360 may control insertion/retraction motion of the imaging system and the touchpad 362 may control steering of the imaging system.

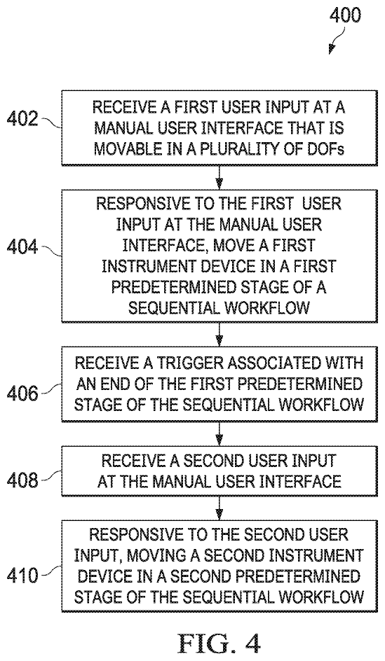

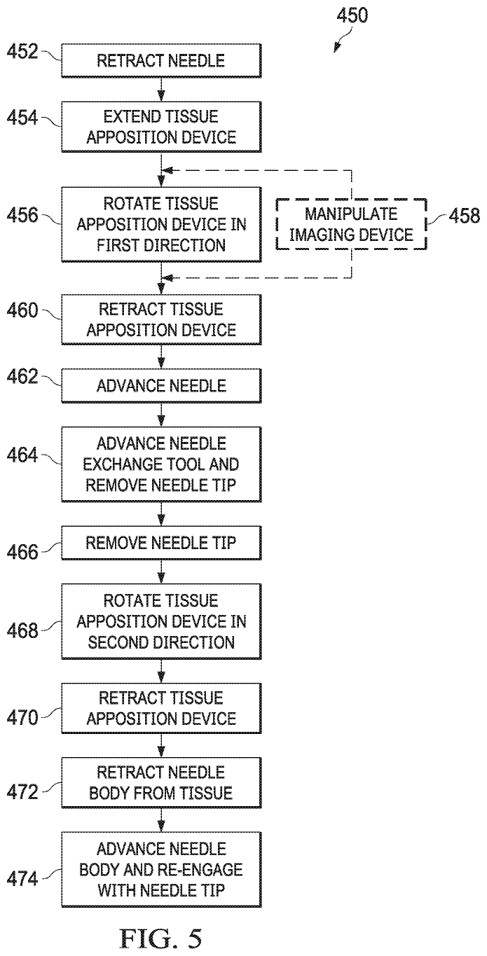

In some examples, a manual user interface system (e.g., systems 100, 302, 322, 324, 352, 354) may be used to control actuation of an instrument system (e.g., instrument system 200) in performing a sequential workflow comprised of predetermined stages associated with functions of the component instrument devices of an instrument system. As described in the methods and workflows below, a plurality or all of the motions, actuations, and functions of an instrument system may be controlled by a single manual user interface such as the knob 102. A single knob that controls multiple instrument devices in various speeds, various directions, and various forces for multiple or all stages of a sequential procedure may greatly simplify the user experience as compared to methods that require multiple user interfaces or multiple human users to perform the same sequential procedure. FIG. 4 is a flowchart illustrating a method 400 for controlling an instrument system. FIG. 5 is a flowchart illustrating predetermined stages in a sequential workflow 450 for a suturing procedure that may be performed with the instrument system 200. Method 400 and other methods for controlling an instrument system described herein may refer to the predetermined stages of the sequential workflow 450 for a suturing procedure, however the method 400 and the manual user interface systems described herein are not limited to use in suturing procedures. In alternative examples, the methods of FIGS. 4, 6, and 7 may be used with instrument systems to perform any of a variety of procedures that have a sequential workflow of predetermined stages. Such procedures may include, for example, dissection, biopsy, ablation. irrigation, or other interventional medical procedures.

As describe with reference to FIG. 5, the sequential workflow 450 for a suturing procedure may be performed with the instrument system 200. Each stage of the sequential workflow may correspond to one or a series of motions, actuations, or functions of a component instrument device of the instrument system 200. At some stages, a single component instrument device of the instrument system may be actuated. In other stages, two or more component instrument devices of the instrument system may be actuated.

At a stage 452, following positioning an instrument system (e.g., instrument system 200) to a suitable location for a suture bite (e.g., suture bite 222A), the component instrument device being controlled may be a suture needle (e.g. suture needle 214) that may be moved with a retraction motion. For example, an arcuate suture needle 214 may be retracted by rotating the needle to an open position. The stage 452 may optionally be omitted, for example, in cases where the arcuate suture needle 214 is already in an open position.

At a stage 454, the component instrument device being controlled may be a tissue apposition tool (e.g. an apposition tool 218) that may be extended from the working channel 208. In some examples, the apposition tool may include a helical shaped component that extends toward the tissue surface. The helical shaped component may be pushed forward against the tissue. In other examples, the apposition tool may engage tissue with using opposed jaws, clamps, or other tissue grasping mechanisms. During the stage 454, the tissue apposition tool may be controlled to move in insertion or retraction directions.

At a stage 456, the component instrument device being controlled may again be the tissue apposition tool but the motion being controlled may be a rotation motion in a first direction. For example, a helical apposition tool 218 may be rotated such that the helical shaped component drives into the tissue with a clockwise corkscrew motion. Optionally within the stage 456, the tissue apposition tool may be rotated in a second direction (e.g. counterclockwise), opposite the first direction, to finely adjust the depth of the helical shaped component within the tissue. For example, if the helically threaded tissue apposition tool is initially rotated too deeply into the tissue, reverse threading of the apposition tool may remove some of the helical thread from the tissue. Optionally at the stage 456, the tissue apposition tool may be both rotated and further extended. In other words, the stage 456 may permit control of both translational motion of the tissue apposition tool 218 and rotation motion of the tissue apposition tool 218.

At a stage 458, the component instrument device being controlled may be an imaging system (e.g. an imaging system 240 or an imaging system coupled to a different robotically-assisted manipulator) that may be advanced, retracted, changed in direction, or otherwise manipulated between or in parallel with (e.g., during or in combination with) any of the stages of the workflow 450.

At a stage 460, the component instrument device being controlled may again be the tissue apposition tool. The tissue apposition tool and, accordingly, the tissue engaged with the tissue apposition tool may be retracted. For example, once the helical shaped component of the tissue apposition tool 218 has been driven into the tissue to a desired depth, the helical shaped component can be retracted, bringing the tissue closer to the suturing apparatus and into the path of the suturing needle 214.

At a stage 462, the component instrument device being controlled may be the suturing needle. The suturing needle may be advanced into the apposed tissue. For example, the arcuate suture needle 214 may be advanced by rotating the needle to a closed position while the tissue apposition tool 218 holds the engaged tissue in an apposed position.

At a stage 464, the component instrument device being controlled may be a needle exchange tool that may be advanced to the suture apparatus. For example, the needle exchange tool 219 may be advanced through the working channel 209. The stage 464 may be optionally omitted, for example, in cases where a needle tip capture mechanism 221 attached to the needle exchange tool 219 is already present at a sufficient position in the working channel 209.

At a stage 466, the component instrument device being controlled may be a needle tip capture mechanism that may remove a needle tip portion of the suturing needle from a body of the suturing needle. For example, the needle tip capture mechanism 221 may grasp and remove a tip portion of the suturing needle 214 that is coupled to the suture strand. The needle tip capture mechanism 221 may grasp, remove, and hold the tip portion, including the attached suture strand.

At a stage 468, the component instrument device being controlled may again be the tissue apposition tool which may be rotated in a second direction, opposite the first direction, to withdraw the tissue apposition tool from the tissue. For example, a helical apposition tool 218 may be rotated such that the helical shaped component moves with a counterclockwise corkscrew motion until the helical shaped component becomes unthreaded and separated from the tissue.

At a stage 470, the component instrument device being controlled may again be the tissue apposition tool which may be retracted. For example, after removal from tissue, the helical apposition tool 218 may be retracted away from the tissue and into the working channel 208.

At a stage 472, the component instrument device being controlled may be the suturing needle which may be retracted from the tissue. For example, the arcuate suture needle 214 may be retracted by rotating the needle to the open position.

At a stage 474, the component instrument device being controlled may again be the suturing needle. The suturing needle may be advanced and reengaged with the tip portion of the suturing needle. For example, the arcuate suture needle 214 may be advanced by rotating the needle to a closed position at which it reengages the needle tip capture mechanism 221 holding the needle tip portion. After reengagement, the suture needle may be refitted with the tip portion and the attached suture strand. Stage 474 may optionally be performed after an instrument system (e.g., instrument system 200) is moved, such as being moved to suitable location for another suture bite (e.g., suture bite 222B).

With reference to FIG. 4, The method 400 for controlling an instrument system may be described with reference to the stages 452 and 454 of sequential workflow 450 but may be used with any of the stages of workflow 450 or other sequential workflows. The method 400 may be focused on a transition between two predetermined stages of a sequential workflow, such as the stage 452 and 454 of the sequential workflow 450. With reference to FIG. 4, at a process 402, a first user input may be received at a manual user interface system that is movable in a plurality of degrees of freedom. For example, the manual user interface system 100 includes the knob 102 which is movable in translational and rotational degrees of freedom and which may be translated or rotated by a user input.

At a process 404, responsive to the first user input, a first instrument device may be moved in a first predetermined stage of a sequential workflow. For example, the suture needle 214 of the instrument system 200 may be retracted, at the predetermined stage 452 of sequential workflow 450, in response to the user input at the knob 102.

At a process 406, a trigger associated with an end of the first predetermined stage of the sequential workflow may be received. For example, a user input may provide the trigger associated with the end of the stage 452 of retracting the suture needle. A trigger signaling a transition between workflow stages may be a user input such as a pressing the knob 102 down (e.g. motion in the −Y direction) or a signal from a sensor that a predetermined threshold has been reached. For example, a force sensor reading may indicate that tissue has been touched or punctured. In other examples, an encoder reading may indicate that a tool has moved a predetermined distance. The processes 402-406 may be associated, for example, with retracting a suturing needle at the stage 452 of the sequential workflow 450.

At a process 408, a second user input may be received at the manual user interface system. For example, the knob 102 may be translated or rotated by a user input in a same degree of freedom as the first user input or may be moved in a different degree of freedom.

At a process 410, responsive to the second user input, a second instrument device may be moved in a second predetermined stage of the sequential workflow. For example, the tissue apposition tool 218 of the instrument system 200 may be extended, at predetermined stage 454 of sequential workflow 450, in response to the user input at the knob 102.

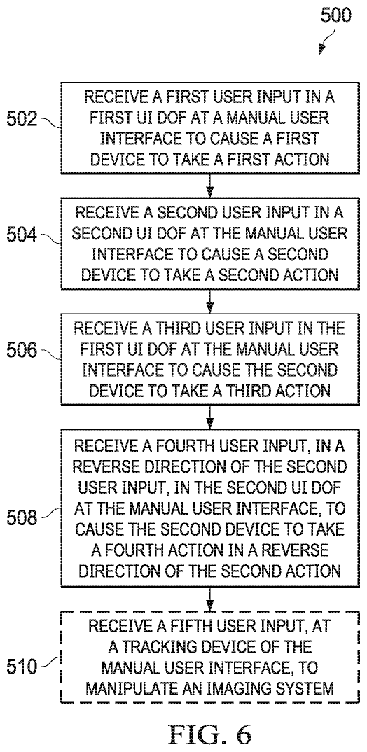

In some examples, a single manual user interface device such as knob 102 may be moved or respond to user input forces in multiple translational and/rotational directions to perform the sequential workflow with the instrument devices of an instrument system. At each stage of the sequential workflow, a user input at the knob will cause a predetermined motion or action of one or more instrument devices. The instrument device that is actuated and the type of actuation that occurs may depend on the current stage of the sequential workflow. For example, at a first stage of the sequential workflow, a user input at the manual user interface device may actuate a first instrument device to perform an action, but at a second stage of the sequential workflow, a user input at the manual user interface (even an input in the same degree of freedom of motion of the knob) may actuate a second instrument device to perform a different action. FIG. 6 is a flowchart illustrating a method 500 for controlling an instrument system with a single manual user interface device that moves or responds to forces in multiple degrees of freedom. This type of control may allow for greater user discretion when executing a stage of the sequential workflow and may be suited for users with significant experience or know-how.

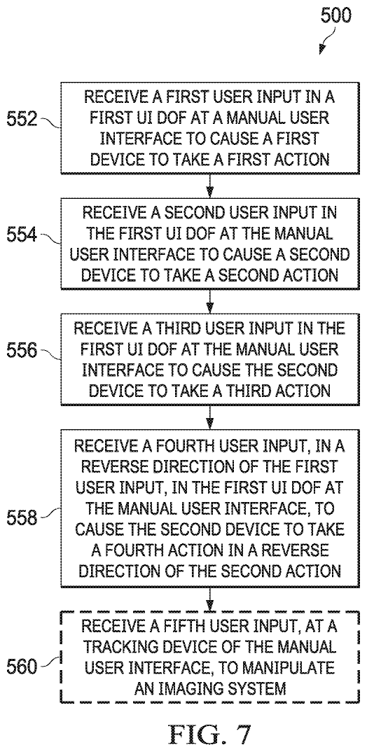

In other examples, the knob may be constrained to move or respond to forces in a single translational or rotational direction to perform the sequential workflow. FIG. 7 is a flowchart illustrating a method 550 for controlling an instrument system with a single manual user interface device that moves or responds to forces in a single degree of freedom to perform the sequential workflow. For example, a motion of the knob 102 may be limited to rotational motion to perform all of the stages of the sequential workflow. Optionally, other degrees of freedom of the single manual user interface device may be assigned to perform administrative functions not directly related to performing the tasks of the sequential workflow. For example, the knob 102 may be limited to rotational motion to perform the stages, but the administrative function of registering the beginning or end of a stage may be assigned to a translational motion of the knob 102 (e.g. a button push action in the −Y direction). The type of control described in FIG. 7 may limit user discretion when executing a stage of the sequential workflow and may be suited for procedures with minimal complexity. In some examples the method for control may be selected based on the complexity of the procedure, the user experience level, or other factors. In other examples, an instrument system may be controlled with a single manual interface that is movable in two or more degrees of freedom. In some examples, the degrees of freedom of movement of the single manual interface may be locked or available based on the type of procedure, the stages of a sequential workflow, or other factors or conditions.

With reference to FIG. 6, movement of instrument system devices to perform a predetermined sequential workflow may be controlled by movements or inputs in multiple degrees of freedom at a single manual user interface device as described in method 500. The sequential workflow for an interventional procedure may include stages defined by functions of the instrument system. Various functions or actions of the instrument devices may be controlled by various inputs of the manual user interface system. The user inputs associated with each instrument device action may be predetermined or may be pre-selected by the user. Method 500 may refer to the stages of the sequential workflow 450 performed with the instrument system 200, however the method 500 is not limited and may be used to perform any sequential workflow. As compared to method 550 of FIG. 7, the method 500 of FIG. 6 may allow for more granular control and greater user discretion but may require more user awareness and training.

At a process 502, a first user input may be received in a first degree of freedom of motion at a manual user interface system to cause a first instrument device to take a first action. The first action may be associated with a first stage of a sequential workflow. For example and with reference to sequential workflow 450, a first user input may be a rotation (e.g., the first degree of freedom) of the knob 102 to cause the suture needle 214 (e.g., the first instrument device) to retract or move to an open position (e.g., the first action) at stage 452 of the workflow 450. In this example, rotation of the knob 102 counterclockwise (e.g. about the Y-axis) may retract the suture needle 214. The user input at the knob 102 may activate a binary action associated with the stage 452, such as a single automated retraction motion of the suture needle. Alternatively, a variable amount of user input at the knob 102 may cause a corresponding amount of motion of the suture needle. For example, a quarter turn of the knob 102 may be associated with a 90 degree rotation (or another predetermined rotation) of the suture needle. A rotation of the knob 102 may be a full 360 degree rotation, a 90 degree rotation of the knob, or another predetermined rotation amount that corresponds with a predetermined amount of instrument device motion. In some examples, a user input in the reverse direction of the first degree of freedom may move the first instrument device in an opposite direction. Reversing the direction may allow a user to finely control the amount of movement of the instrument device. In some examples, haptic sensations such as click sensations that correspond to the motion of the first instrument may be delivered to the user through the knob 102. In some examples, an input at the manual user interface system may signal the completion of the stage and, optionally, advancement to the next stage of the workflow. For example, a user input in the −Y direction (e.g. a downward press) may be a predetermined signal indicating the end of the stage 452. In other examples, the completion of the stage may be determined by sensor information, imaging information, or other input sources. In some examples, an instrument device may be retained or held stationary at the end of the stage while the manual user interface becomes responsive to user inputs for a subsequent stage. For example after the knob 102 has been rotated to retract the suture needle and stage 452 has been completed, the suture needle may be held or retained in the retracted position without further input at the knob 102. The procedure may transition to the stage 454 and the tissue apposition tool 218 may be extended responsive to user input at the knob 102 while the suture needle remains in the retracted position.

At a process 504, a second user input may be received in a second degree of freedom of motion at the manual user interface system to cause a second instrument device to take a second action. The second action may be associated with a second stage of a sequential workflow. For example and with reference to sequential workflow 450, a second user input may be a translation or push (e.g. the second degree of freedom) of the knob 102 forward (e.g. +Z direction) to cause the tissue apposition tool 218 (e.g., the second instrument device) to extend (e.g., the second action) from the working channel 208 at stage 454 of the workflow 450. In some examples, a variable amount of user input at the knob 102 may cause a corresponding amount of motion of the tissue apposition tool. For example, a 2 mm movement of the knob 102 in the +Z direction may be associated with a 1 mm advancement (or another predetermined distance) of the tissue apposition tool. In some examples, a user input in the reverse direction of the second degree of freedom may move the second instrument device in an opposite direction. Reversing the direction may allow a user to finely control the amount of movement of the tissue apposition tool, optionally under visual guidance of the imaging system. In some examples, haptic sensations such as click sensations that correspond to the motion of the first instrument may be delivered to the user through the knob 102. In some examples, an input at the manual user interface system may signal the completion of the stage and, optionally, advancement to the next stage of the workflow. For example, a user input in the −Y direction (e.g. a downward press) may be a predetermined signal indicating the end of the stage 454. In other examples, the completion of the stage may be determined by other input sources.

At a process 506, a third user input may be received in the first degree of freedom of motion at the manual user interface system to cause the second instrument device to take a third action. The third action may be associated with a third stage of a sequential workflow. For example and with reference to sequential workflow 450, a third user input may be a rotation (e.g., the first degree of freedom) of the knob 102 to cause the tissue apposition tool 218 (e.g., the second instrument device) to rotate (e.g., the third action) at stage 456 of the workflow 450. In some examples, a clockwise (e.g. about the Y-axis) rotation of the knob 102 may rotate a helical tissue apposition tool 218 toward tissue and a counterclockwise rotation of the knob may rotate the helical tissue apposition tool away from the tissue. In some examples, a variable amount of user input at the knob 102 may cause a corresponding amount of rotation of the tissue apposition tool. Reversing the direction may allow a user to finely control the amount of movement of the tissue apposition tool, optionally under visual guidance of the imaging system. In some examples, haptic sensations such as click sensations that correspond to the motion of the first instrument may be delivered to the user through the knob 102. In some stages of the sequential workflow, two or more actuations of an instrument device may be activated simultaneously. For example, at the process 506, the helical tissue apposition tool may be extended while simultaneously rotating. In this example, rotational and translational user inputs may be delivered to the knob 102. Some stages of the sequential workflow may allow simultaneous inputs in different degrees freedom and other stages may permit user inputs in a single degree of freedom. In some examples, an input at the manual user interface system may signal the completion of the stage and, optionally, advancement to the next stage of the workflow. For example, a user input in the −Y direction (e.g. a downward press) may be a predetermined signal indicating the end of the stage 456. In other examples, the completion of the stage may be determined by other input sources.

At a process 508, a fourth user input in a reverse direction of the second user input may be received in the second degree of freedom of motion at the manual user interface system to cause the second instrument device to take a fourth action in a reverse direction of the second action. The fourth action may be associated with a fourth stage of a sequential workflow. For example and with reference to sequential workflow 450, a fourth user input may be a translation or pull (e.g. the second degree of freedom) of the knob 102 in a backward direction (e.g. the −Z direction, reverse of the +Z direction of process 504) to cause the tissue apposition tool 218 (e.g., the second instrument device) and any tissue attached to the helical component of the tissue apposition tool to retract (e.g., the fourth action) at stage 460 of the workflow 450. In some examples, the user input at the knob 102 may cause a corresponding amount of motion of the tissue apposition tool. In some examples, haptic sensations such as click sensations that correspond to the motion of the first instrument may be delivered to the user through the knob 102. In some examples, an input at the manual user interface system may signal the completion of the stage and, optionally, advancement to the next stage of the workflow. For example, a user input in the −Y direction (e.g. a downward press) may be a predetermined signal indicating the end of the stage 460. In other examples, the completion of the stage may be determined by other input sources.

At a process 510, a fifth user input may be received at a tracking device of the manual user interface system to manipulate an imaging system. For example, the fifth user input may be an interaction with a display screen 120 that causes manipulation (e.g., insertion/retraction or directional changes) of an imaging system (e.g. an imaging system 240 or an imaging system coupled to a different robotically-assisted manipulator) at stage 458 of the workflow 450. The process 510 may be optional and may occur during or between any of the stages of the processes 502-508.

Optionally, additional user inputs at the manual user interface system (e.g., the knob 102) may cause instrument devices of the instrument system (e.g., instrument system 200) to take additional actions at each of the remaining stages (e.g., stages 462-474) of the sequential workflow 450.

With reference to FIG. 7, movement of instrument system devices to perform a predetermined sequential workflow may be controlled by movement or input in a single degree of freedom at a single manual user interface device as described in method 550. The sequential workflow for an interventional procedure may include stages defined by functions of the instrument system. Various functions or actions of the instrument devices may be controlled by an input to the manual user interface system in a single degree of freedom. The user input in a single degree of freedom may be used to advance through the predetermined stages of the sequential workflow and may be predetermined or pre-selected by the user. In some examples, the user input in the single degree of freedom may be in a first direction to move forward through the stages of the sequential workflow and may be in an opposite direction to move in a reverse order through the stages of the sequential workflow. For example, rotation of the knob 102 in a first direction of the rotational degree of freedom may operate the instrument system through a forward sequence of stages of a workflow, and rotation of the knob in a second direction, opposite the first direction, of the rotational degree of freedom may operate the device through a reverse sequence of stages of the workflow. In some examples, rotation in the second direction may step back or undo the current or prior completed stages of the workflow. Although operation of an instrument device during a stage of the predetermined sequential workflow may be controlled by a movement of the manual use interface device in a single degree of freedom, the manual user interface device may be movable in additional degrees of freedom of motion to perform administrative or supporting tasks such as providing an indication of an end of a stage of the predetermined workflow or providing an input at the touchpad of the knob to control an imaging system. Method 550 may refer to the stages of the sequential workflow 450 performed with the instrument system 200, however the method 550 is not limited and may be used to perform any sequential workflow. As compared to method 500, the method 550 may allow for more automated control and require less user discretion but may allow less granular control of the actuations at each stage of the sequential workflow.

At a process 552, a first user input may be received in a first degree of freedom of motion at a manual user interface system to cause a first instrument device to take a first action. The first action may be associated with a first stage of a sequential workflow. For example and with reference to sequential workflow 450, a first user input may be a rotation (e.g., the first degree of freedom) of the knob 102 to cause the suture needle 214 (e.g., the first instrument device) to retract or move to an open position (e.g., the first action) at stage 452 of the workflow 450. In this example, rotation of the knob 102 counterclockwise (e.g. about the Y-axis) may retract the suture needle 214. In some examples, a user input in the reverse direction of the first degree of freedom may move the first instrument device in an opposite direction. Reversing the direction may allow a user to undo or reverse the movement of the instrument device. A rotation of the knob 102 to complete the action may be a full 360 degree rotation, a 90 degree rotation of the knob, or another predetermined rotation amount that corresponds with a predetermined amount of instrument device motion. In some examples, a haptic sensation such as click sensation that corresponds to the motion of the first instrument may be delivered to the user through the knob 102. In some examples, an instrument device may be retained or held stationary at the end of the stage while the manual user interface becomes responsive to user inputs for a subsequent stage. For example after the knob 102 has been rotated to retract the suture needle and stage 452 has been completed, the suture needle may be held or retained in the retracted position without further input at the knob. The procedure may transition to the stage 454 and the tissue apposition tool 218 may be extended responsive to user input at the knob 102 while the suture needle remains in the retracted position.

In some examples, an input at the manual user interface system, in a degree of freedom different from the first degree of freedom, may signal the completion of the stage and, optionally, prompt a transition to the next stage of the workflow. For example, a user input in the −Y direction (e.g., a downward press) may be a predetermined signal indicating the end of the stage 452. In some examples, the transition between stages of the sequential workflow may be triggered by sensor data, which may include image data. For example, force sensor data may indicate that an apposition device has touched tissue and a transition from an advancement stage (e.g., stage 454) to a rotation stage (e.g., stage 456) may be triggered. As another example, encoder data may indicate that the suture needle has moved to a retracted position (e.g., stage 452) and a transition to an apposition device advancement stage (e.g., stage 454) may be triggered. As another example, analyzed imaging data or device sensor data (e.g., position sensor information) may indicate that the apposition device and the connected tissue have been sufficiently retracted into the tissue apposition chamber, thereby triggering the end of the apposition instrument retraction stage (e.g., stage 460) and the transition to the needle advancement stage (e.g., stage 462).

At a process 554, a second user input may be received in the same first degree of freedom of motion at the manual user interface system to cause a second instrument device to take a second action. The second action may be associated with a second stage of a sequential workflow. For example and with reference to sequential workflow 450, the second user input may be the rotation (e.g., the first degree of freedom) of the knob 102 to cause the tissue apposition tool 218 (e.g., the second instrument device) to extend (e.g., the second action) from the working channel 208 at stage 454 of the workflow 450. In some examples, a user input in the reverse direction of the first degree of freedom, during the stage, may move the second instrument device in an opposite direction. Reversing the direction may allow a user to finely control the amount of movement of the tissue apposition tool, optionally under visual guidance of the imaging system. Continued rotation in the reverse direction of the first degree of freedom may step back or undo the current or prior completed stages of the workflow. In some examples, haptic sensations such as click sensations that correspond to the motion of the first instrument may be delivered to the user through the knob 102. In some examples, an input at the manual user interface system or received sensor information may signal the completion of the stage and, optionally, advancement to the next stage of the workflow.

At a process 556, a third user input may be received in the first degree of freedom of motion at the manual user interface system to cause the second instrument device to take a third action. The third action may be associated with a third stage of a sequential workflow. For example and with reference to sequential workflow 450, a third user input may be the rotation (e.g., the first degree of freedom) of the knob 102 to cause the tissue apposition tool 218 (e.g., the second instrument device) to rotate (e.g., the third action) at stage 456 of the workflow 450. In some examples, a clockwise (e.g. about the Y-axis) rotation of the knob 102 may rotate a helical tissue apposition tool 218 toward tissue and a counterclockwise rotation of the knob may rotate the helical tissue apposition tool away from the tissue, during the stage 456. Reversing the direction may allow a user to finely control the amount of movement of the tissue apposition tool, optionally under visual guidance of the imaging system. In some examples, haptic sensations such as click sensations that correspond to the motion of the first instrument may be delivered to the user through the knob 102. In some examples, an input at the manual user interface system or received sensor information may signal the completion of the stage and, optionally, advancement to the next stage of the workflow.

At a process 558, a fourth user input may be received in the first degree of freedom of motion at the manual user interface system to cause the second instrument device to take a fourth action in a reverse direction of the second action. The fourth action may be associated with a fourth stage of a sequential workflow. For example and with reference to sequential workflow 450, a fourth user input may be the rotation (e.g., the first degree of freedom) of the knob 102 to cause the tissue apposition tool 218 (e.g., the second instrument device) and any tissue attached to the helical component of the tissue apposition tool to retract (e.g., the fourth action) at stage 460 of the workflow 450. In some examples, haptic sensations such as click sensations that correspond to the motion of the first instrument may be delivered to the user through the knob 102. In some examples, an input at the manual user interface system or received sensor information may signal the completion of the stage and, optionally, advancement to the next stage of the workflow.

At a process 560, a fifth user input may be received at a tracking device of the manual user interface system to manipulate an imaging system. For example, the fifth user input may be an interaction with a touchscreen of the display screen 120 that causes manipulation (e.g., insertion/retraction or directional changes) of an imaging system (e.g. an imaging system 240 or an imaging system coupled to a different robotically-assisted manipulator) at stage 458 of the workflow 450. The process 510 may be optional and may occur during or between any of the stages of the processes 552-558.

Optionally, additional user inputs at the manual user interface system (e.g., the knob 102) in the first degree of freedom of motion may cause instrument devices of the instrument system (e.g., instrument system 200) to take additional actions at each of the remaining stages (e.g., stages 462-474) of the sequential workflow 450.

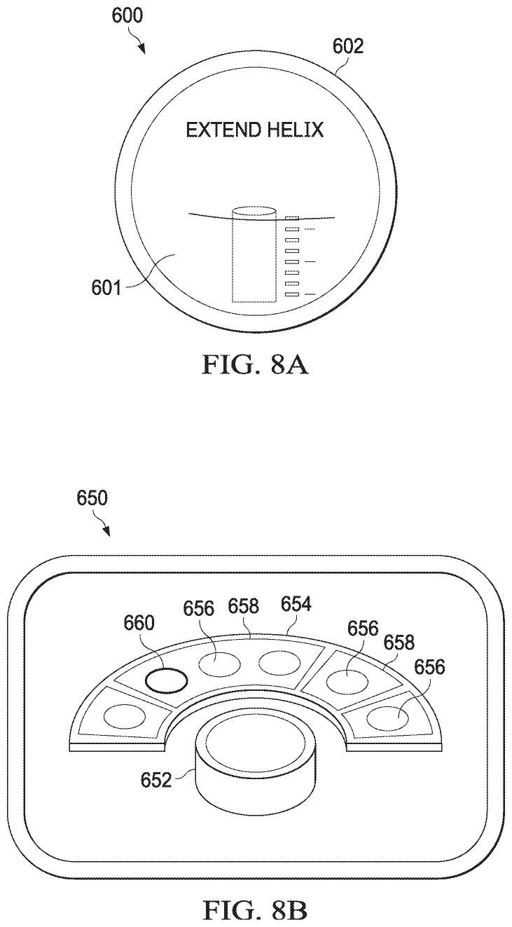

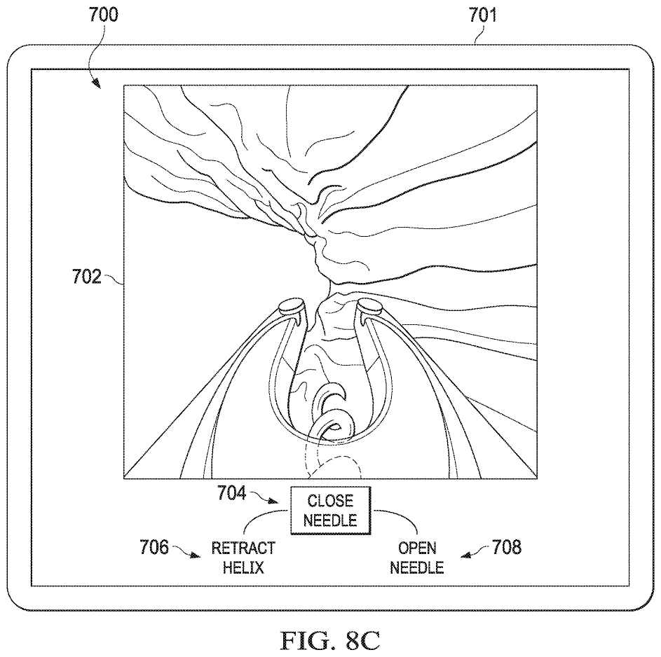

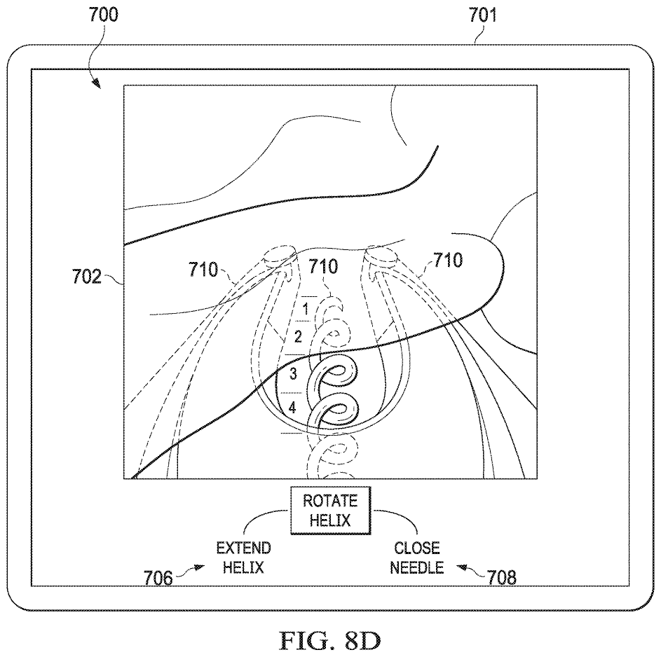

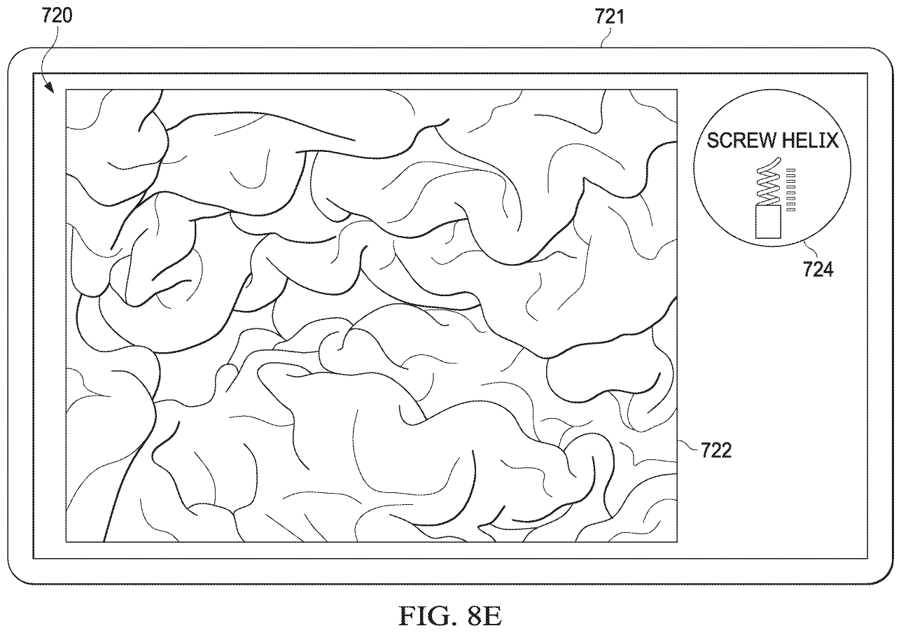

Throughout the stages of a sequential workflow for performing a procedure, a graphical user interface may provide the user with images, graphical representations, textual information, sensor measurement data, or other displayed information that may be relevant to the procedure. FIG. 8A illustrates a graphical user interface 600 that may be displayed on a display screen 601 of a knob 602. The knob 602 may be substantially similar to the knob 102. The display screen 601 may display information relevant to a current stage of the sequential workflow, and the displayed information may change with the transition to the next stage of the workflow. In this example, the display screen 601 may display information relevant to stage 454 of the workflow 450. For example, at stage 454, the tissue apposition tool may be a helical apposition device and the display screen 601 may graphically illustrate a measure of the extension of the apposition device. When the workflow transitions from stage 454 to stage 456, the information displayed on the display screen 601 may transition to information relevant to rotation of the tissue apposition tool at stage 456. Additionally or alternatively, the information displayed on the display screen 601 may be displayed on other display screens of a robotically-assisted medical system, such as display screens 308, 328, 358 and 1110.

FIG. 8B illustrates a control panel 650 (e.g. the control panel 301, 321, 351) including a knob 652 (e.g., knob 102) and a display screen 654. The display screen 654 may display a graphical user interface including icons 656 corresponding to each stage of a sequential workflow (e.g. the stages sequential workflow 450). In some examples the stages of the sequential workflow may be bounded by markers 658 that demarcate sub-procedures of the sequential workflow. A stage indicator 660 such as a highlighted ring may indicate the stage of the sequential workflow for which the knob is currently active. In some examples, the stage indicator may be an arrow on a display screen of the knob 652 that points to the currently active stage. In some examples, the icons 656 associated with the stages of the sequential workflow may be arranged in an arcuate shape surrounding a portion of the knob 652. In other examples the icons may have a linear arrangement, a ring arrangement, or other suitable arrangement for displaying a sequential workflow.

FIG. 8C illustrates a graphical user interface 700 that may be displayed on a display screen 701. The display screen 701 may be located on a knob 102 or on other display screens of a robotically-assisted medical system, such as display screens 308, 328, 358 and 1110. The display screen 701 may provide an endoscopic camera view 702 from an imaging system (e.g., imaging system 240) and may include a stage indicator such as a highlighted title of the current stage 704 (e.g., the stage of the sequential workflow 450) along with the titles for the previous stage 706 and the subsequent stage 708 displayed in sequential order with the current stage 704.

FIG. 8D illustrates the graphical user interface 700 including virtual or ghost features 710 that provide a virtual representation of instrument system components that may be obscured by tissue in the field of view of the imaging system. Alternatively, the ghost features may provide a preview, virtual representation of instrument system components at their expected position relative to the tissue at the conclusion of the current stage of the workflow.

FIG. 8E illustrates a graphical user interface 720 that may be displayed on a display screen 721. The display screen 721 may be located on a knob 102 or on other display screens of a robotically-assisted medical system, such as display screens 308, 328, 358 and 1110. The display screen 721 may provide an endoscopic camera view 722 from an imaging system (e.g., imaging system 240) and may also display a stage indicator 724 with information relevant to a current stage of the sequential workflow. In this example, the display screen 721 may display information relevant to stage 456 of the workflow 450. For example, at stage 456, the tissue apposition tool may be a helical apposition device and the display screen 701 may graphically illustrate relevant information via the stage indicator 724 such as a measure or graphic representation of the extension and/or rotation of the apposition device.

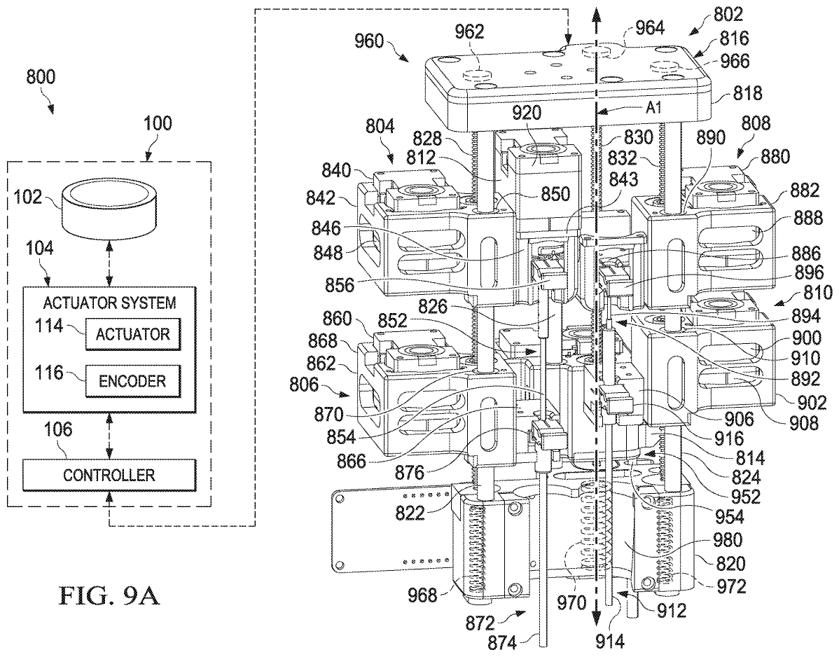

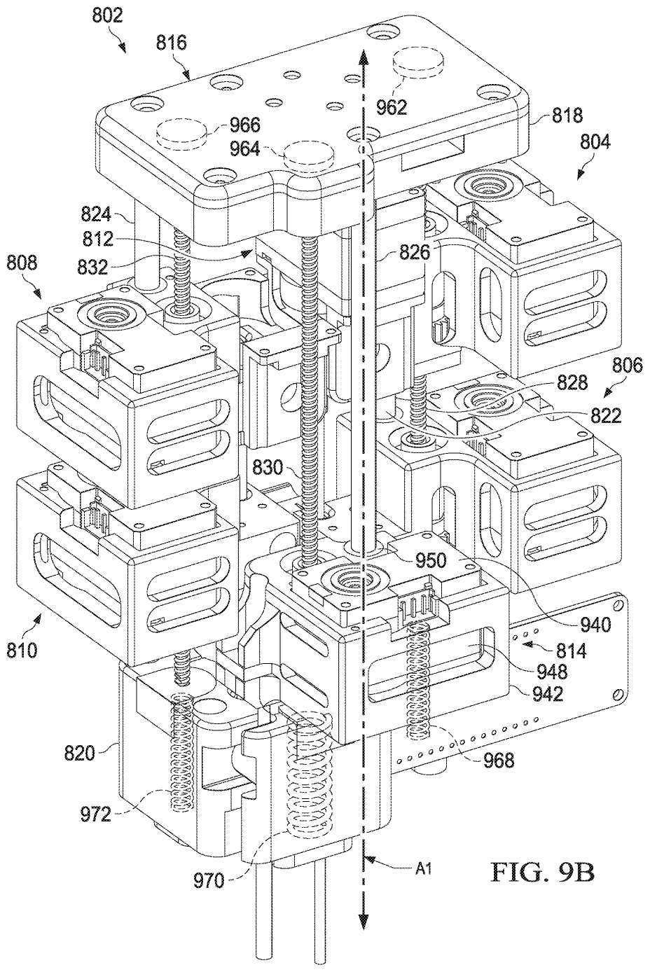

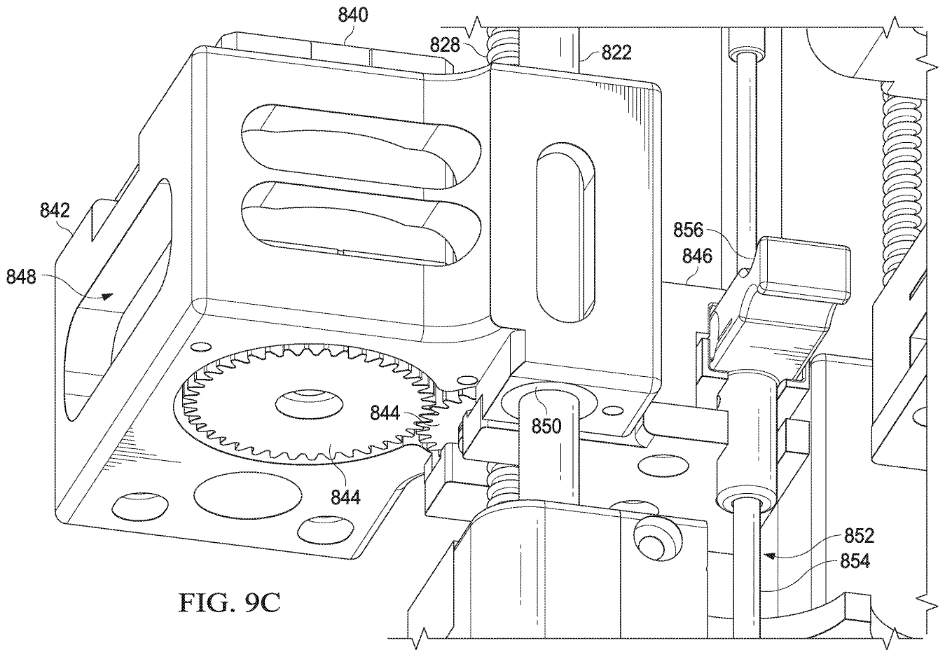

The manual user interface system and the methods for controlling an instrument system with the manual user interface system described above may be implemented in a robotically-assisted medical system using an instrument actuation apparatus that may be a component of a manipulator assembly (e.g. manipulator assembly 1102). For example, the instrument actuation apparatus may be coupled to and supported by a robotically-actuated arm that is mounted to a floor, wall, stationary console, or movable console within a medical environment. In various examples, the arm may be robotically actuated, manually actuated, or have a combination of robotic and manual actuation. In other examples, the instrument actuation apparatus may be carried by an operator or coupled to an instrument system (e.g., a manual endoscope) that is carried by an operator or coupled to an instrument system that is mounted. As used herein, a manual endoscope is an endoscope whose distal end articulation is operated by manual controls (e.g., by hand at manual controls at a proximal end region of the endoscope). FIGS. 9A-9C illustrate an example of an instrument actuation system 800 that may be used to actuate a predetermined sequential workflow, but other instrument actuation systems may also be suitable. In some examples, the instrument actuation system 800 may be used to implement instrument actuations responsive to non-predetermined operator commands. FIG. 9A illustrates an instrument actuation system 800 that may be used to actuate one or more instrument devices of an instrument system. The instrument actuation system 800 may include the manual user interface system 100 that communicates user inputs from the knob 102 to an instrument actuation apparatus 802. The instrument actuation apparatus 802 may include actuation mechanisms 804-814, each assigned to provide motion for a degree of freedom of an instrument device of an instrument system (e.g., instrument system 200). The actuation mechanisms 804-814 may receive control signals from the controller 106 for actuating the functions of the instrument devices. The control signals to the actuation mechanisms may be received wirelessly or via wired connection. The actuation mechanisms 804-814 may be powered, for example, by electrical cabling operatively coupled to a power supply or batteries. FIG. 9B illustrates an opposite side of the instrument actuation apparatus 802 from that shown in FIG. 9A. FIG. 9C illustrates a detailed portion of the actuation mechanism 804.

The instrument actuation apparatus 802 may include a frame 816 including a proximal platform 818, a distal platform 820, and three elongate support members 822, 824, 826 extending between the platforms 818, 820. The elongate support member 822, 824, 826 may extend generally parallel to a longitudinal axis A1, and the platforms 818, 820 may extend generally perpendicular to the longitudinal axis A1. In alternative examples, fewer or more horizontal support platforms may be included, and fewer or more elongate support members may be included. The instrument actuation apparatus 802 may also include elongated threaded members 828, 830, 832 (e.g., lead screws) extending generally parallel to the longitudinal axis A1 between the platforms 818, 820.

Each actuation mechanism 804-814 may drive an independent motion of an instrument device of an instrument system (e.g. instrument system 200) in a degree of freedom (including in reciprocal or bi-directional directions of the degree of freedom). For example, the actuation mechanism 804 may drive insertion and retraction motion of the shaft of a tissue apposition tool (e.g. tissue apposition tool 218). The actuation mechanism 806 may drive insertion and retraction motion of a sheath of the tissue apposition tool. The actuation mechanism 808 may drive a needle tip capture mechanism (e.g., needle tip capture mechanism 221). The actuation mechanism 810 may drive an insertion and retraction motion of the needle exchange tool (e.g., needle exchange tool 219). The actuation mechanism 812 may drive bi-directional rotational motion of the tissue apposition tool (e.g. tissue apposition tool 218). The actuation mechanism 814 may drive bi-directional motion of the suture needle (e.g., suture needle 214).

The actuation mechanism 804 may include a servomechanism or motor 840, an actuator housing 842, a gear system 844 (FIG. 9C), and an instrument device connector 846. The actuator housing 842 includes a housing chamber 848 that supports the motor 840 and includes a channel 850 sized for through passage of the elongate support member 822. An instrument device 852 may be removably couplable to the connector 846. The instrument device 852 may include a shaft 854 and a proximal coupling portion 856 at the proximal end of the shaft 854 that engages the connector 846 from a lateral direction (e.g. generally perpendicular to the longitudinal axis A1). The device connector 846 may allow for quick release and replacement of the instrument device 852. The gear system 844 may connect the output of the motor 840 to the elongated threaded member 828. When actuated by the motor 840, the movement of the gear system 844 may cause the actuation mechanism 804 to travel proximally or distally in the direction A1, along the elongated threaded member 828. As the actuation mechanism 804 moves in the direction A1, so too does the attached instrument device 852. In some examples, the instrument device 852 may be a tissue apposition tool 218 and the motor 840 may drive an insertion and retraction motion of the tissue apposition tool 218.

The actuation mechanism 806 may include a servomechanism or motor 860, an actuator housing 862, a gear system (not shown but similar to gear system 844), and an instrument device connector 866. The actuator housing 862 includes a housing chamber 868 that supports the motor 860 and includes a channel 870 sized for through passage of the elongate support member 822. An instrument device 872 may be removably couplable to the connector 866. The instrument device 872 may include a shaft 874 and a proximal coupling portion 876 at the proximal end of the shaft 874 that engages the connector 866 from a lateral direction (e.g. generally perpendicular to the longitudinal axis A1). The device connector 866 may allow for quick release and replacement of the instrument device 872. The gear system of the actuation mechanism 806 may connect the output of the motor 860 to the elongated threaded member 828. When actuated by the motor 860, the movement of the gear system may cause the actuation mechanism 806 to travel proximally or distally in the direction A1, along the elongated threaded member 828. As the actuation mechanism 806 moves in the direction A1, so too does the attached instrument device 872. In some examples, the instrument device 872 may be a sheath for the tissue apposition tool 218 and the motor 860 may drive an insertion and retraction motion of the sheath. The actuation mechanisms 804, 806 may be driven independently so that the sheath may be extended or withdrawn relative to the tissue apposition tool 218. In some examples, the shaft 854 of the instrument device 852 may extend within and move relative to the shaft 874.

The actuation mechanism 808 may include a servomechanism or motor 880, an actuator housing 882, a gear system (not shown but similar to gear system 844), and an instrument device connector 886. The actuator housing 882 includes a housing chamber 888 that supports the motor 880 and includes a channel 890 sized for through passage of the elongate support member 824. An instrument device 892 may be removably couplable to the connector 886. The instrument device 892 may include a shaft 894 and a proximal coupling portion 896 at the proximal end of the shaft 894 that engages the connector 886 from a lateral direction (e.g. generally perpendicular to the longitudinal axis A1). The device connector 886 may allow for quick release and replacement of the instrument device 892. The gear system of the actuation mechanism 808 may connect the output of the motor 880 to the elongated threaded member 832. When actuated by the motor 880, the movement of the gear system may cause the actuation mechanism 808 to travel proximally or distally in the direction A1, along the elongated threaded member 832. As the actuation mechanism 808 moves in the direction A1, so too does the attached instrument device 892. In some examples, the instrument device 892 may be a needle tip capture mechanism 221 and the motor 880 may drive a catch and release motion of the needle tip capture mechanism 221.

The actuation mechanism 810 may include a servomechanism or motor 900, an actuator housing 902, a gear system (not shown but similar to gear system 844), and an instrument device connector 906. The actuator housing 902 includes a housing chamber 908 that supports the motor 900 and includes a channel 910 sized for through passage of the elongate support member 824. An instrument device 912 may be removably couplable to the connector 906. The instrument device 912 may include a shaft 914 and a proximal coupling portion 916 at the proximal end of the shaft 914 that engages the connector 906 from a lateral direction (e.g. generally perpendicular to the longitudinal axis A1). The device connector 906 may allow for quick release and replacement of the instrument device 912. The gear system of the actuation mechanism 810 may connect the output of the motor 900 to the elongated threaded member 832. When actuated by the motor 900, the movement of the gear system may cause the actuation mechanism 810 to travel proximally or distally in the direction A1, along the elongated threaded member 832. As the actuation mechanism 810 moves in the direction A1, so too does the attached instrument device 912. In some examples, the instrument device 912 may be a needle exchange tool 219 and the motor 900 may drive an insertion and retraction motion of the needle exchange tool 219. The actuation mechanisms 808, 810 may be driven independently so that the needle exchange tool 219 and the needle tip capture mechanism 221 may move independently. In some examples, the shaft 894 of the instrument device 892 may extend within and move relative to the shaft 914.

The actuation mechanism 812 may include a servomechanism or motor 920 and a gear system (not shown but similar to gear system 844). The actuator housing 842 of the actuation mechanism 804 may include a support platform 843 that supports the motor 920. The gear system of the actuation mechanism 812 may connect the output of the motor 920 to the instrument device 852. When actuated by the motor 920, the movement of the gear system may cause rotational motion of the instrument device 852. In some examples, the instrument device 852 may be the tissue apposition tool 218 and the motor 920 may drive bi-directional rotational motion of the tissue apposition tool 218. The actuation mechanisms 804, 812 may be driven independently so that the instrument device 852 may rotate independently of its linear motion.

The actuation mechanism 814 may include a servomechanism or motor 940, an actuator housing 942, and a gear system (not shown but similar to gear system 844). The actuator housing 942 includes a housing chamber 948 that supports the motor 940 and includes a channel 950 sized for through passage of the elongate support member 826. The actuator housing 942 may be coupled to an instrument device 952 that may include a drive mechanism 954 and suture needle (not shown) at a distal end of the drive mechanism 954. The gear system of the actuation mechanism 814 may connect the output of the motor 940 to the elongated threaded member 830. When actuated by the motor 940, the movement of the gear system may cause the actuation mechanism 814 to travel proximally or distally in the direction A1, along the elongated threaded member 832. As the actuation mechanism 814 moves in the direction A1, so too does the attached instrument device 952. In some examples, the instrument device 952 may include the suture needle 214, and the motor 940 may drive bi-directional motion of the suture needle 214.

The instrument actuation apparatus 802 may also include a sensing system 960 including force sensors 962, 964, 966 (e.g., load sensors) housed within the proximal platform 818. The force sensor 962 may contact the proximal end of the elongated threaded member 828. The force sensor 964 may contact the proximal end of the elongated threaded member 830. The force sensor 966 may contact the proximal end of the elongated threaded member 832. The distal ends of the elongated threaded members may be biased toward the force sensors with biasing members such as springs. For example, a spring 968 may bias the elongated threaded member 828 toward the force sensor 962. A spring 970 may bias the elongated threaded member 830 toward the force sensor 964. A spring 972 may bias the elongated threaded member 832 toward the force sensor 966. The springs 968, 970, 972 may be housed within the distal platform 820. The force sensors detect forces, in tension and/or compression, that are transmitted through the actuator housings from the coupled instrument devices. The detected forces may be used to generate haptic feedback to the knob 102 to provide the user with information about the forces encountered by the instrument devices. For example, when a tissue apposition tool 218 encounters a resistance, such as tissue, as it is advanced by the motion of the motor 840 and/or rotated by the motion of the motor 920, the resistance force on the apposition tool 218 may be transmitted to the elongated threaded member 828 which transmits the force to the force sensor 962. The force sensor 962 may generate haptic feedback to the knob 102, for example, by increasing the torque to the knob 102 making it harder to turn, thus simulating the manual sensation of advancing a tool into tissue. The spring characteristics (e.g., size, stiffness, material) may be different from one another and may be selected to provide a desired preload force on the elongated threaded members.

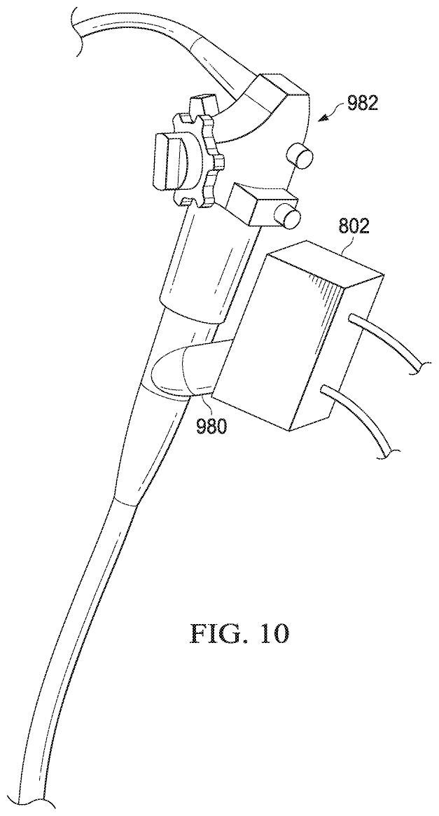

The distal platform 820 may also include an instrument system engagement port 980 to which a proximal end portion of an instrument system 982 (e.g., instrument system 200 or an endoscope) may be coupled as shown in FIG. 10. The instrument system 982 may engage with the port 980 from a lateral direction (e.g. generally perpendicular to the longitudinal axis A1). As shown in FIG. 10, the instrument actuation apparatus 802 may be coupled at the port 980 to the proximal end portion of an instrument system 982. The instrument devices 852, 872, 912, 952 may extend into the instrument system 982 while the instrument system is coupled to the instrument actuation apparatus.

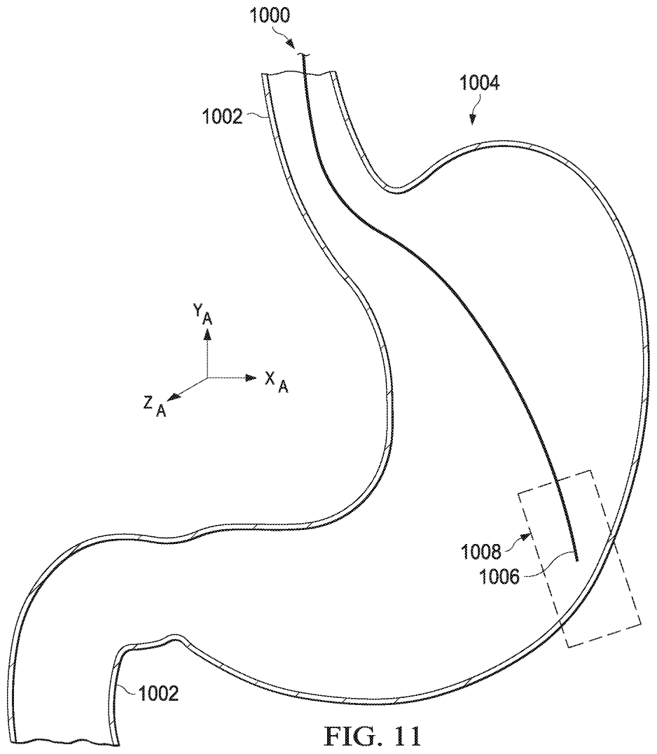

FIG. 11 illustrates an endoscopic instrument system 1000 (e.g., the instrument system 200) extending within anatomic passageways 1002 of an anatomical structure 1004. In some examples the anatomic structure 1004 may be a stomach. The anatomic structure 1004 has an anatomical frame of reference (X_{A}, Y_{A}, Z_{A}). A distal end portion 1006 of the endoscopic instrument system 1000 may be advanced into an anatomic opening (e.g., a patient mouth) and through the anatomic passageways 1002 to perform a medical procedure, such as a suturing procedure, at or near target tissue located in a region 1008 of the anatomic structure 1004 using any of the methods or systems described herein.

Aspects of this disclosure herein can be part of a computer-assisted teleoperational manipulator system, sometimes referred to as a robotically-assisted manipulator system or a robotic system. The manipulator system can include one or more manipulators that can be operated with the assistance of an electronic controller (e.g., computer) to move and control functions of one or more instruments when coupled to the manipulators.

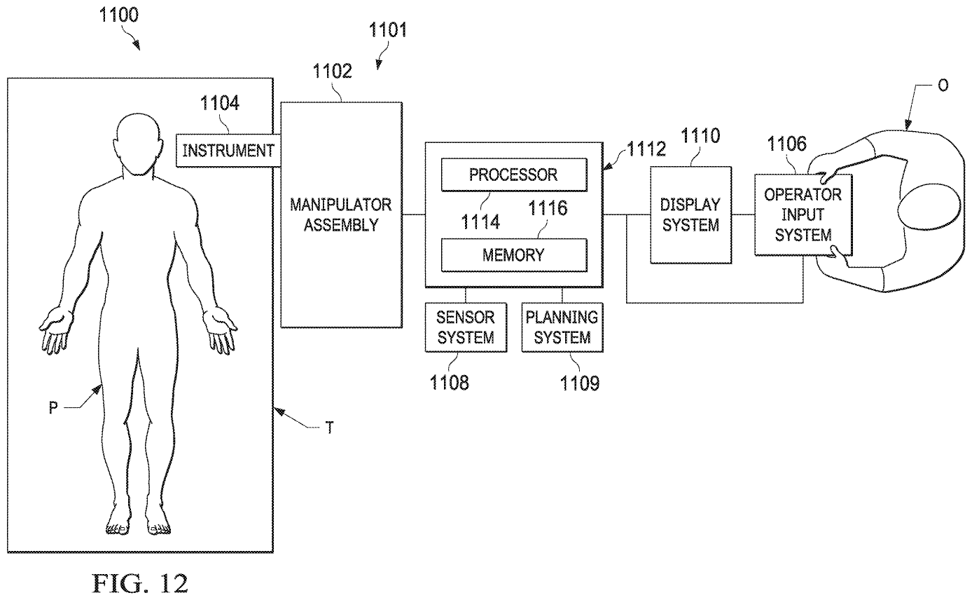

FIG. 12 illustrates an embodiment of a robotically-assisted manipulator system for use with the tools described herein. The manipulator system can be used, for example, in surgical, diagnostic, therapeutic, biopsy, or non-medical procedures, and is generally indicated by the reference numeral 1100. As shown in FIG. 12, a robotically-assisted manipulator system 1100 can include one or more manipulator assemblies 1102 for operating one or more medical instrument systems 1104 (e.g., instrument system 200) in performing various procedures on a patient P positioned on a table T in a medical environment 1101. For example, the manipulator assembly 1102 can drive catheter or end effector motion, can apply treatment to target tissue, and/or can manipulate control members. The manipulator assembly 1102 can be teleoperated, non-teleoperated, or a hybrid teleoperated and non-teleoperated assembly with select degrees of freedom of motion that can be motorized and/or teleoperated and select degrees of freedom of motion that can be non-motorized and/or non-teleoperated. An operator input system 1106, which can be inside or outside of the medical environment 1101, generally includes one or more control devices (e.g., manual user interface system 100) for controlling manipulator assembly 1102. Manipulator assembly 1102 supports medical instrument system 1104 and can optionally include a plurality of actuators or motors that drive inputs on medical instrument system 1104 in response to commands from a control system 1112. The actuators can optionally include drive systems that when coupled to medical instrument system 1104 can advance medical instrument system 1104 into a naturally or surgically created anatomic orifice. Other drive systems can move the distal end of medical instrument in multiple degrees of freedom, which can include three degrees of linear motion (e.g., linear motion along the X, Y, Z Cartesian axes) and in three degrees of rotational motion (e.g., rotation about the X, Y, Z Cartesian axes). The manipulator assembly 1102 can support various other systems for irrigation, treatment, or other purposes. Such systems can include fluid systems (including, for example, reservoirs, heating/cooling elements, pumps, and valves), generators, lasers, interrogators, and ablation components.

Robotically-assisted manipulator system 1100 also includes a display system 1110 for displaying an image or representation of the surgical site and medical instrument system 1104 generated by an imaging system 1109 which can include an imaging system, such as an endoscopic imaging system. Display system 1110 and operator input system 1106 can be oriented so an operator O can control medical instrument system 1104 and operator input system 1106 with the perception of telepresence. A graphical user interface can be displayable on the display system 1110 and/or a display system of an independent planning workstation.

In some examples, the endoscopic imaging system components of the imaging system 1109 can be integrally or removably coupled to medical instrument system 1104. However, in some examples, a separate imaging device, such as an endoscope, attached to a separate manipulator assembly can be used with medical instrument system 1104 to image the surgical site. The endoscopic imaging system 1109 can be implemented as hardware, firmware, software, or a combination thereof which interact with or are otherwise executed by one or more computer processors, which can include the processors of the control system 1112.

Robotically-assisted manipulator system 1100 can also include a sensor system 1108. The sensor system 1108 can include a position/location sensor system (e.g., an actuator encoder or an electromagnetic (EM) sensor system) and/or a shape sensor system (e.g., an optical fiber shape sensor) for determining the position, orientation, speed, velocity, pose, and/or shape of the medical instrument system 1104. The sensor system 1108 can also include temperature, pressure, force, or contact sensors or the like.

Robotically-assisted manipulator system 1100 can also include a control system 1112. Control system 1112 includes at least one memory 1116 and at least one computer processor 1114 for effecting control between medical instrument system 1104, operator input system 1106, sensor system 1108, and display system 1110. In some examples, the control system 1112 may include the controller 106 of the manual user interface system 100. Control system 1112 also includes programmed instructions (e.g., a non-transitory machine-readable medium storing the instructions) to implement a procedure using the robotically-assisted manipulator system including for navigation, steering, imaging, engagement feature deployment or retraction, applying treatment to target tissue (e.g., via the application of energy), or the like.

Control system 1112 can optionally further include a virtual visualization system to provide navigation assistance to operator O when controlling medical instrument system 1104 during an image-guided surgical procedure. Virtual navigation using the virtual visualization system can be based upon reference to an acquired pre-operative or intra-operative dataset of anatomic passageways. The virtual visualization system processes images of the surgical site imaged using imaging technology such as computerized tomography (CT), magnetic resonance imaging (MRI), fluoroscopy, thermography, ultrasound, optical coherence tomography (OCT), thermal imaging, impedance imaging, laser imaging, nanotube X-ray imaging, and/or the like. The control system 1112 can use a pre-operative image to locate the target tissue (using vision imaging techniques and/or by receiving user input) and create a pre-operative plan, including an optimal first location for performing treatment. The pre-operative plan can include, for example, a planned size to expand an expandable device, a treatment duration, a treatment temperature, and/or multiple deployment locations.

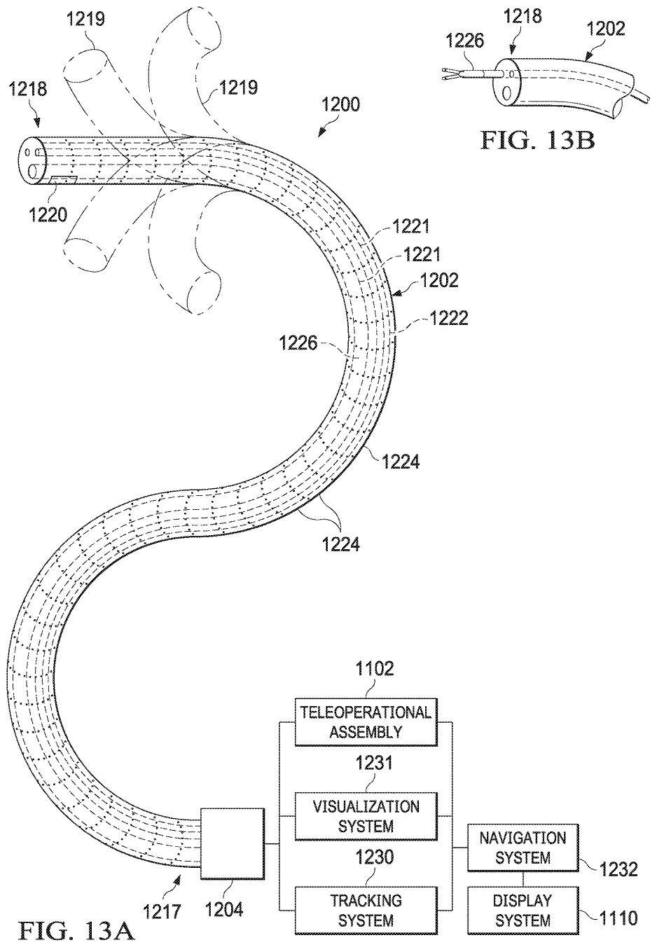

FIG. 13A shows a medical instrument system 1200 (e.g. instrument system 200) according to some embodiments. In some embodiments, medical instrument system 1200 can be used in an image-guided medical procedure. In some examples, medical instrument system 1200 can be used for non-teleoperational exploratory procedures or in procedures involving traditional manually operated medical instruments, such as endoscopy. In some embodiments, medical instrument system 1200 is interchangeable with, or a variation of, medical instrument system 1104 of FIG. 12.

Medical instrument system 1200 includes elongate flexible device 1202, such as a flexible catheter or endoscope (e.g., gastroscope, bronchoscope), coupled to a drive unit 1204. Elongate flexible device 1202 includes a flexible body 1216 having proximal end 1217 and distal end, or tip portion, 1218. In some embodiments, flexible body 1216 has an approximately 14-20 mm outer diameter. Other flexible body outer diameters can be larger or smaller. Flexible body 1216 can have an appropriate length to reach certain portions of the anatomy, such as the lungs, sinuses, throat, or the upper or lower gastrointestional region, when flexible body 1216 is inserted into a patient's oral or nasal cavity.

Medical instrument system 1200 optionally includes a tracking system 1230 for determining the position, orientation, speed, velocity, pose, and/or shape of distal end 1218 and/or of one or more segments 1224 along flexible body 1216 using one or more sensors and/or imaging devices. The entire length of flexible body 1216, between distal end 1218 and proximal end 1217, can be effectively divided into segments 1224. Tracking system 1230 can optionally be implemented as hardware, firmware, software or a combination thereof which interact with or are otherwise executed by one or more computer processors, which can include the processors of control system 1112 in FIG. 12.

Tracking system 1230 can optionally track distal end 1218 and/or one or more of the segments 1224 using a shape sensor 1222. In some embodiments, tracking system 1230 can optionally and/or additionally track distal end 1218 using a position sensor system 1220, such as an electromagnetic (EM) sensor system. In some examples, position sensor system 1220 can be configured and positioned to measure six degrees of freedom, e.g., three position coordinates X, Y, Z and three orientation angles indicating pitch, yaw, and roll of a base point or five degrees of freedom, e.g., three position coordinates X, Y, Z and two orientation angles indicating pitch and yaw of a base point.

Flexible body 1216 includes one or more channels 1221 sized and shaped to receive one or more medical instruments 1226. In some embodiments, flexible body 1216 includes two channels 1221 for separate instruments 1226, however, a different number of channels 1221 can be provided. FIG. 13B is a simplified diagram of flexible body 1216 with medical instrument 1226 extended according to some embodiments. In some embodiments, medical instrument 1226 can be used for procedures and aspects of procedures, such as surgery, biopsy, ablation, mapping, imaging, illumination, irrigation, or suction. Medical instrument 1226 can be deployed through channel 1221 of flexible body 1216 and used at a target location within the anatomy. Medical instrument 1226 can include, for example, image capture devices, biopsy instruments, ablation instruments, catheters, laser ablation fibers, and/or other surgical, diagnostic, or therapeutic tools. Medical tools can include end effectors having a single working member such as a scalpel, a blunt blade, a lens, an optical fiber, an electrode, and/or the like. Other end effectors can include, for example, forceps, graspers, balloons, needles, scissors, clip appliers, and/or the like. Other end effectors can further include electrically activated end effectors such as electrosurgical electrodes, transducers, sensors, imaging devices and/or the like. Medical instrument 1226 can be advanced from the opening of channel 1221 to perform the procedure and then retracted back into the channel when the procedure is complete. Medical instrument 1226 can be removed from proximal end 1217 of flexible body 1216 or from another optional instrument port (not shown) along flexible body 1216. The medical instrument 1226 can be used with an image capture device (e.g., an endoscopic camera) also within the elongate flexible device 1202. Alternatively, the medical instrument 1226 can itself be the image capture device.

Medical instrument 1226 can additionally house cables, linkages, or other actuation controls (not shown) that extend between its proximal and distal ends to controllably the bend distal end of medical instrument 1226. Flexible body 1216 can also house cables, linkages, or other steering controls (not shown) that extend between drive unit 1204 and distal end 1218 to controllably bend distal end 1218 as shown, for example, by broken dashed line depictions 1219 of distal end 1218. In some examples, at least four cables are used to provide independent “up-down” steering to control a pitch motion of distal end 1218 and “left-right” steering to control a yaw motion of distal end 1218. In embodiments in which medical instrument system 1200 is actuated by a robotically-assisted assembly, drive unit 1204 can include drive inputs that removably couple to and receive power from drive elements, such as actuators, of the teleoperational assembly. In some embodiments, medical instrument system 1200 can include gripping features, manual actuators, or other components for manually controlling the motion of medical instrument system 1200. The information from tracking system 1230 can be sent to a navigation system 1232 where it is combined with information from visualization system 1231 and/or the preoperatively obtained models to provide the physician or other operator with real-time position information.

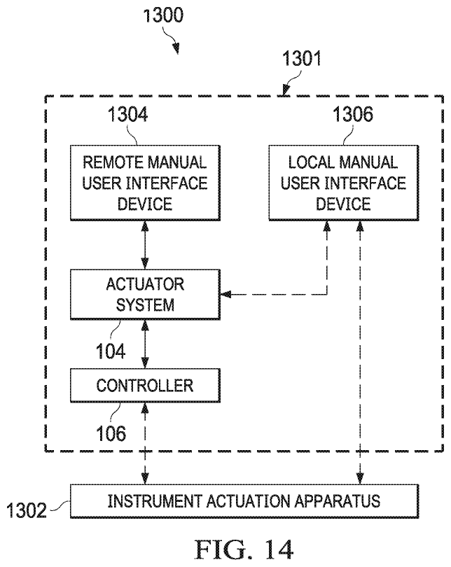

In some examples, a manual user interface system for controlling an instrument system may be mounted to and supported by a stationary or movable control panel within a medical environment. In other examples, the manual user interface system may be carried by an operator or coupled to an instrument system (e.g., a manual endoscope) carried by an operator or mounted. FIG. 14 illustrates an example of an instrument actuation system 1300 that may be used to actuate one or more instrument devices of an instrument system. The instrument actuation system 1300 may include a manual user interface system 1301 that communicates user inputs to an instrument actuation apparatus 1302 to operate multiple actions of an instrument system (e.g., instrument system 200). The manual user interface system 1301 may be a component of an operator input system (e.g., operator input system 1106) and the instrument actuation apparatus 1302 may be a component of a manipulator assembly (e.g. manipulator assembly 1102). In some examples, the instrument actuation apparatus 1302 may be coupled to and supported by a robotically-actuated arm that is mounted to a floor, wall, stationary console, or movable console within a medical environment. In various examples, the arm may be robotically actuated, manually actuated, or have a combination of robotic and manual actuation. In other examples, the instrument actuation apparatus may be carried by an operator or coupled to an instrument system (e.g., a manual endoscope) carried by an operator or otherwise mounted.

The manual user interface system 1301 may include a remote manual user interface device 1304 movable in one or more degrees of freedom in response to input from a user. The remote manual user interface device 1304 may be separated or spatially remote from the instrument actuation apparatus 1302 and may actuate servo-controlled degrees of freedom of motion of the instrument actuation apparatus 1302. For example, the remote manual user interface device 1304 may be mounted to a stationary or movable control panel (e.g., control panel 301) within a medical environment or may be included in a hand-held controller that is attachable to an operator's hand or arm. The remote manual user interface device 1304 may be movable in translational and/or rotational degrees of freedom. For example, the remote manual user interface device 1304 may include a toggle, button, joystick, scroll wheel, trackball, or a knob 102. The manual user interface system 1301 may include the actuator system 104 and controller 106, as previously described for communicating operator commands from the remote manual user interface device 1304 to the instrument actuation apparatus 1302 to operate actions of an instrument system.

The manual user interface system 1301 may include a local manual user interface device 1306 movable in one or more degrees of freedom in response to input from a user. The local manual user interface device 1306 may be mounted to or supported by the instrument actuation apparatus 1302 and may control motion of one or more of the instrument devices of the instrument system (e.g. instrument system 200). For example, the local manual user interface device 1306 may include a handle, grip, knob, or other structure coupled to an instrument device of the instrument system that may be directly manipulated by an operator to translate, rotate, or otherwise locally control one or more instrument devices coupled to the instrument actuation apparatus 1302. The local manual user interface device 1306 may also actuate servo-controlled degrees of freedom of motion of the instrument actuation apparatus 1302 via the actuator system 104 and the controller 106.

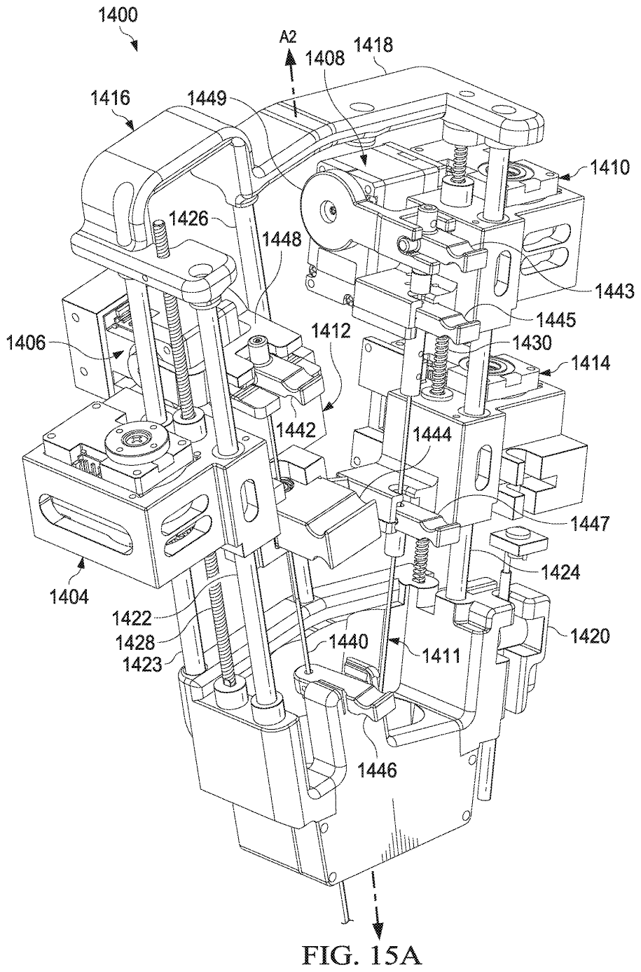

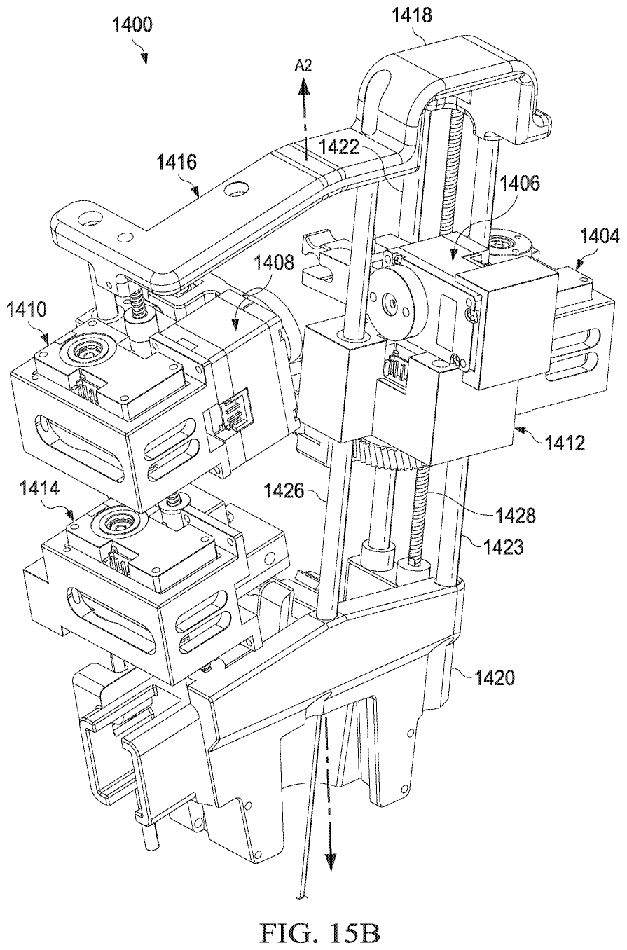

FIG. 15A illustrates an example of an instrument actuation apparatus 1400 that may be used to operate multiple actions of an instrument system (e.g., instrument system 200). The instrument actuation apparatus 1400 may be an example of an instrument actuation apparatus 1302 and may be responsive to controls provided by a remote manual user interface device 1452 or 1480, as described below. FIG. 15B illustrates an opposite side of the instrument actuation apparatus 1400 from that shown in FIG. 15A. The instrument actuation apparatus 1400 may be similar to the instrument actuation apparatus 802 but may be adapted to provide an additional linear degree of freedom of motion and may be adapted to accommodate different instrument systems or instrument devices.

The instrument actuation apparatus 1400 may include actuation mechanisms 1404, 1406, 1408, 1410, 1412, 1414, each assigned to provide motion for a degree of freedom of an instrument device of an instrument system (e.g., instrument system 200). The actuation mechanisms 1404, 1406, 1408, 1410, 1412, 1414 may receive control signals from the controller 106 for actuating the functions of the instrument devices. The control signals to the actuation mechanisms may be received wirelessly or via wired connection. The actuation mechanisms 1404, 1406, 1408, 1410, 1412, 1414 may be powered, for example, by electrical cabling operatively coupled to a power supply or batteries.

The instrument actuation apparatus 1400 may include a frame 1416 including a proximal platform 1418, a distal platform 1420, and four elongate support members 1422, 1423, 1424, 1426 extending between the platforms 1418, 1420. The elongate support members 1422, 1423, 1424, 1426 may be skewed relative to a longitudinal axis A2, and the platforms 1418, 1420 may extend generally perpendicular to the longitudinal axis A2. The skewing of the elongate support members may create a space along the axis A2 for elongate instruments (e.g., laser instruments, balloon instruments, ablation instruments, grasping instruments, tissue apposition tools, etc.) or instrument cabling to pass. The instrument actuation apparatus 1400 may also include elongated threaded members 1428, 1430 (e.g., lead screws) extending at a skewed angle to the longitudinal axis A2 between the platforms 1418, 1420.

Each actuation mechanism 1404, 1406, 1408, 1410, 1412, 1414 may drive an independent motion of an instrument device of an instrument system (e.g. instrument system 200) in a degree of freedom (including in reciprocal or bi-directional directions of the degree of freedom). For example, the actuation mechanism 1404 may drive a linear degree of freedom of motion such as insertion and retraction motion of the shaft of a tissue apposition tool (e.g. tissue apposition tool 218). The actuation mechanism 1406 may drive a linear degree of freedom of motion such as a jaw or grasping mechanism of the tissue apposition tool or the opening and closing of a snare. The actuation mechanism 1408 may drive a linear degree of freedom of motion such as a needle tip capture mechanism (e.g., needle tip capture mechanism 221). The actuation mechanism 1410 may drive a linear degree of freedom of motion such as an insertion and retraction motion of a needle exchange tool (e.g., needle exchange tool 219). The actuation mechanism 1412 may drive bi-directional rotational motion such as a rotation of a helical tissue apposition tool (e.g. tissue apposition tool 218). The actuation mechanism 1414 may drive a linear degree of freedom of motion such as a bi-directional motion of the suture needle (e.g., suture needle 214).

The actuation mechanisms 1404, 1406, 1408, 1410, 1412, 1414 may be similar in structure and function to one or more of the actuation mechanisms 804-814 described above and may each include a servomechanism or motor, an actuator housing, gearing or a drive system, and an instrument device connector. An instrument device (e.g. a tissue apposition device, a needle deployment tool, a suture needle) may be removably coupled to and movable by one or more of the actuation mechanisms 1404, 1406, 1408, 1410, 1412, 1414. For example, a tissue apposition tool 1440 may be attached by proximal coupling portions 1442, 1444, 1446 to respective connectors of the set of actuation mechanisms 1404, 1406, 1412 that may control motion of the tissue apposition tool 1440. In this example, the tissue apposition tool 1440 may include telescoping instrument devices or components. In this example, the actuation mechanism 1406 may cause a pivoting motion of an arm 1448 that drives a linear motion of a component of the tissue apposition tool 1440 to cause a grasper jaw opening and closing. The actuation mechanism 1412 may actuate one or more gears that rotate the tissue apposition tool 1440. The actuation mechanism 1404 may actuate one or more gears that cause linear motion of the tissue apposition tool 1440 along the elongated threaded member 1428 (e.g., a lead screw). In this example, the housings for each of the servomechanisms of the actuation mechanisms 1404, 1406, 1412 may be coupled or unitary such that the linear motion of the actuation mechanism 1404 along the elongated threaded member 1428 also causes corresponding linear motion of the actuation mechanisms 1406 and 1412. In this example, linear degrees of freedom of motion may be actuated by two different mechanisms, namely the movement of the actuation mechanism 1404 along a lead screw and the movement of the pivoting arm 1448 by the actuation mechanism 1406 to linearly move the proximal coupling 1442 of the tissue apposition tool 1440.

A needle deployment tool 1411 may be attached by proximal coupling portions 1443, 1445, 1447 to respective connectors of the set of actuation mechanisms 1408, 1410, 1414 that may control motion of components of the needle deployment tool 1411. The needle deployment tool 1411 may be used to actuate one or more of a needle tip capture mechanism, a needle exchange tool, and a needle. In this example, the needle deployment tool 1411 may include telescoping instrument devices or components. The needle deployment tool 1411 may include instrument components slidable within and/or otherwise independently movable relative to outer instrument components. In this example, the actuation mechanism 1408 may cause a pivoting motion of an arm 1449 that drives a linear motion to actuate a portion of the needle deployment tool 1411, such as a needle tip capture mechanism. The actuation mechanism 1410 may actuate one or more gears that cause linear motion along the elongated threaded member 1430 (e.g., a lead screw) to actuate a portion of the needle deployment tool 1411 (e.g., an insertion and retraction motion of the needle exchange tool). The actuation mechanism 1414 may actuate one or more gears that cause linear motion along the elongated threaded member 1430 actuate a portion of the needle deployment tool 1411 (e.g., a bi-directional motion of the suture needle). In this example, the housings for each of the servomechanisms of the actuation mechanisms 1408, 1410 may be coupled or unitary such that the linear motion of the actuation mechanism 1410 along the elongated threaded member 1430 also causes corresponding linear motion of the actuation mechanism 1408. In this example, linear degrees of freedom of motion may be actuated by two different mechanisms, namely the movement of the actuation mechanisms 1410, 1414 along a lead screw and the movement of the pivoting arm 1449 by the actuation mechanism 1408 to linearly move the proximal coupling 1443 of the needle deployment tool 1411. In this example, the actuation mechanisms 1410, 1414 may be independently movable along the elongated threaded member 1430. In various examples, one or more of the actuation mechanisms may be omitted and a degree of freedom of motion associated with the omitted actuation mechanism may be performed manually by direct operator control.

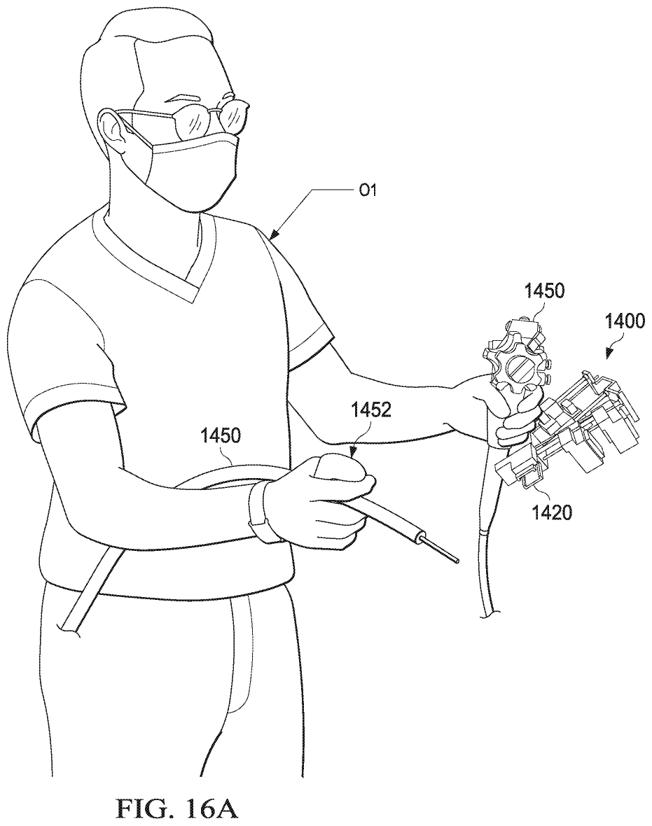

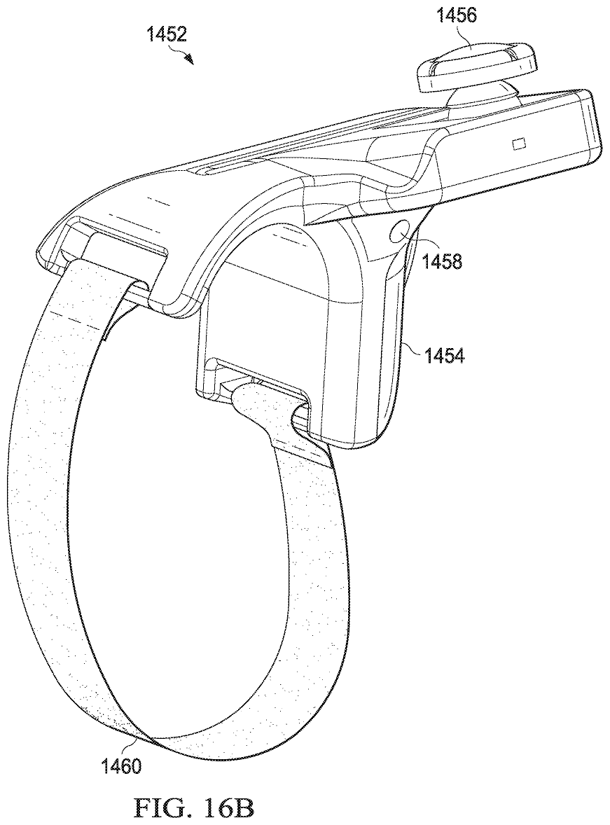

As shown in FIG. 16A, the distal platform 1420 may be coupled to a proximal end portion of an instrument system 1450 (e.g., instrument system 200 or an endoscope), and the instrument devices actuatable by the instrument actuation apparatus 1400 may extend through or along the instrument system 1450. In some examples, the endoscope 1450 and the attached instrument actuation apparatus 1400 may be held or supported by one hand of an operator O1, and a remote manual user interface device 1452 (e.g., the remote manual user interface device 1304) may be held or supported by the other hand of the operator O1. As shown in FIG. 16B, the remote manual user interface device 1452 may include a body 1454 shaped to fit within a palm of a hand and an input device 1456 extending from a surface of the body 1454 and arranged be engaged by a thumb (or any finger) of the hand holding the body 1454. The input device 1456 may include, for example, a joystick. In some examples, the joystick may pivot forward and backward to actuate the actuation mechanism 1404 to drive insertion and retraction motion of the shaft of the tissue apposition tool 1440. In some examples, the joystick may pivot right and left to actuate the actuation mechanism 1412 to drive rotational motion of the shaft of the tissue apposition tool 1440. In some examples, the joystick may be pressed to actuate a binary switch that actuates one or more of the actuation mechanisms 1408, 1410, 1414 in a predetermined sequence to, for example, throw a suture stitch using the needle deployment tool 1411. In other examples, the binary switch may apply an ablation energy. The remote manual user interface device 1452 may also include an input device 1458 such as a button, trigger, or other binary toggle. In some examples, the input device 1458 may be pressed to, for example actuate the actuation mechanism 1406 to activate a grasper or snare of the tissue apposition tool 1440. A strap 1460 or other fastening member may be used to fix the remote manual user interface device 1452 to the operator's hand.

When connected to the operator's hand as shown in FIG. 16A, the operator's hand can, for example, simultaneously hold the body of the endoscope 1450, actuate the knob 1456 with the thumb, and actuate the trigger 1458 with the index finger. Thus, the operator O1 may manipulate the endoscope 1450 (e.g., insertion and roll motions) while also controlling the instrument actuation apparatus 1400 to operate the instrument devices.

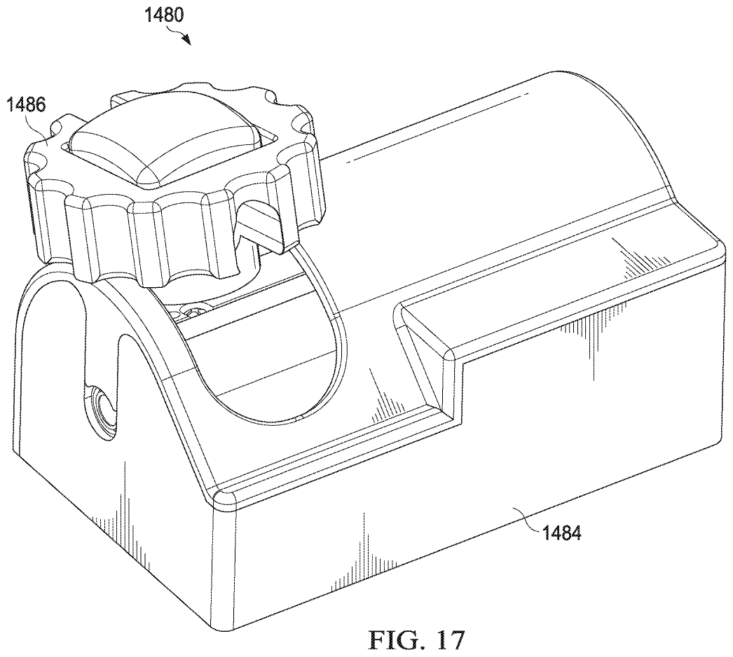

FIG. 17 illustrates a remote manual user interface device 1480 that may be used as an alternative to or together with the remote manual user interface device 1452. The remote manual user interface device 1480 may be mounted to a stationary or movable control panel (e.g., control panel 301) within a medical environment. The remote manual user interface device 1480 may include a body 1484 and an input device 1486 extending from a surface of the body and arranged be engaged by an operator's hand. The input device 1486 may be movable in multiple degrees of freedom. For example, the input device 1486 may pivot forward and/or backward to actuate the actuation mechanism 1404 to drive insertion and retraction motion of the shaft of the tissue apposition tool. In some examples, the input device 1486 may be rotated clockwise and/or counterclockwise to actuate the actuation mechanism 1412 to drive rotational motion of the shaft of the tissue apposition tool. In some examples, the input device 1486 may be pressed to actuate a binary switch that actuates one or more of the actuation mechanisms 1408, 1410, 1414 in a predetermined sequence to, for example, throw a suture stitch or apply ablation energy. In some examples, the remote manual user interface device 1480 may also include an input device such as a button, trigger, or other binary toggle for actuating the actuation mechanism 1406 to activate a grasper or snare.

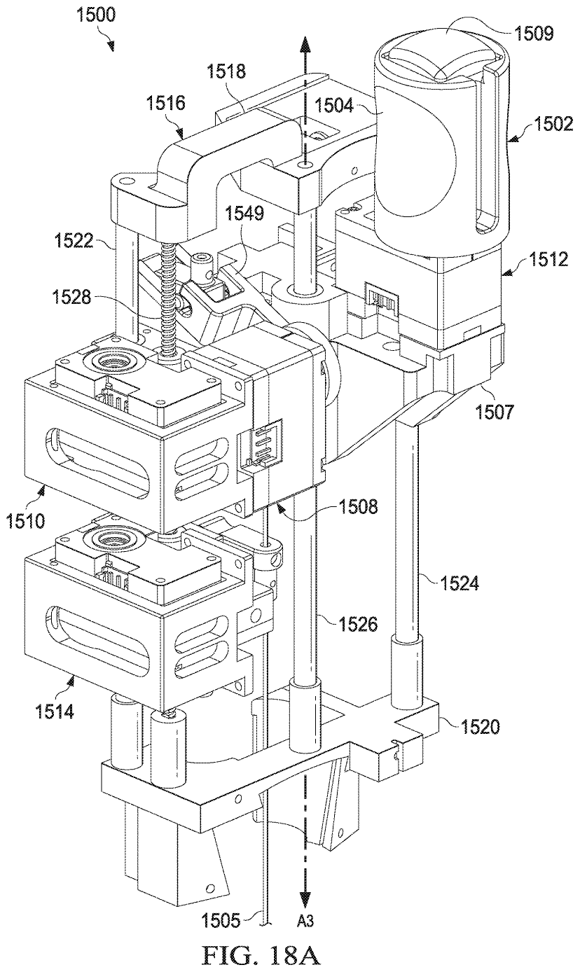

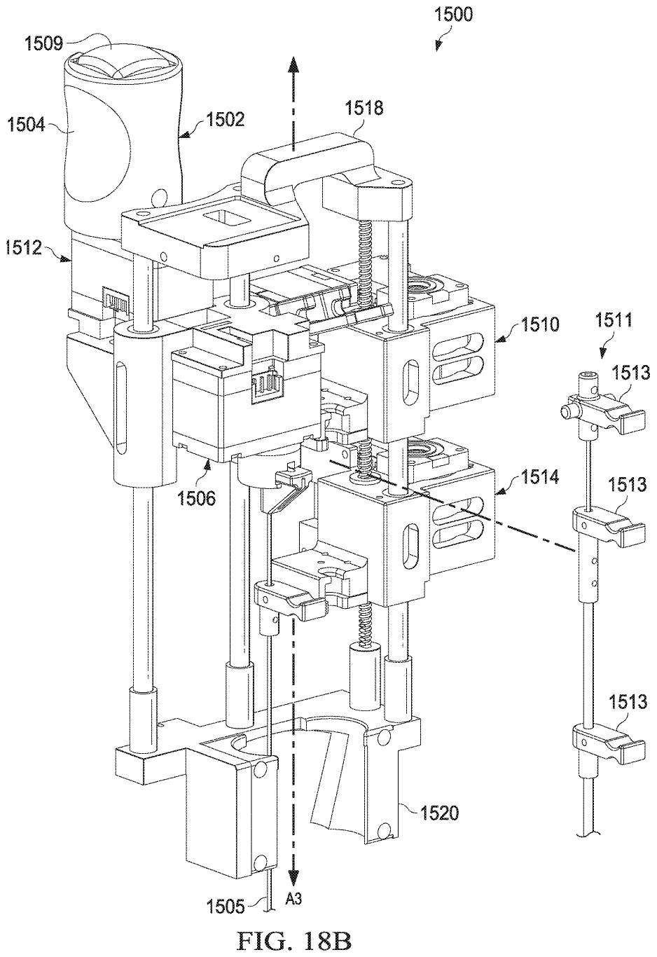

FIGS. 18A and 18B illustrate an example of an instrument actuation apparatus 1500 that may be used to operate multiple actions of an instrument system (e.g., instrument system 200). The instrument actuation apparatus 1500 may be an example of an instrument actuation apparatus 1302 and may be responsive to controls provided by a local manual user interface device 1502 directly coupled to the instrument actuation apparatus 1500. FIG. 18B illustrates an opposite side of the instrument actuation apparatus 1500 from that shown in FIG. 18A. The instrument actuation apparatus 1500 may be similar to the instrument actuation apparatus 802 but may be adapted to allow a user to have direct control of one or more degrees of freedom of motion and receive the haptic information associated with direct control. The instrument actuation apparatus 1500 may also be adapted to accommodate different instrument systems or instrument devices.

The instrument actuation apparatus 1500 may include actuation mechanisms 1506, 1508, 1510, 1512, 1514, each assigned to provide motion for a degree of freedom of an instrument device of an instrument system (e.g., instrument system 200). The actuation mechanisms 1506, 1508, 1510, 1512, 1514 may receive control signals from the controller 106 for actuating the functions of the instrument devices. The control signals to the actuation mechanisms may be received wirelessly or via wired connection. The actuation mechanisms 1506, 1508, 1510, 1512, 1514 may be powered, for example, by electrical cabling operatively coupled to a power supply or batteries. In this example, at least one degree of freedom of an instrument device of the instrument system may be directly manipulated by operator interaction with the local manual user interface device 1502.

The instrument actuation apparatus 1500 may include a frame 1516 including a proximal platform 1518, a distal platform 1520, and three elongate support members 1522, 1524, 1526 extending between the platforms 1518, 1520. The elongate support members 1522, 1524, 1526 may be generally parallel to a longitudinal axis A3, and the platforms 1518, 1520 may extend generally perpendicular to the longitudinal axis A3. The instrument actuation apparatus 1500 may also include one or more elongated threaded members 1528 (e.g., a lead screw) extending generally parallel to the longitudinal axis A3 between the platforms 1518, 1520.

Each actuation mechanism 1506, 1508, 1510, 1512, 1514 may drive an independent motion of an instrument device of an instrument system (e.g. instrument system 200) in a degree of freedom (including in reciprocal or bi-directional directions of the degree of freedom). For example, the actuation mechanism 1506 may drive a linear degree of freedom such as a jaw or grasping mechanism of a tissue apposition tool or the opening and closing of a snare. The actuation mechanism 1508 may drive a needle tip capture mechanism (e.g., needle tip capture mechanism 221). The actuation mechanism 1510 may drive an insertion and retraction motion of the needle exchange tool (e.g., needle exchange tool 219). The actuation mechanism 1512 may drive bi-directional rotational motion of the tissue apposition tool (e.g. tissue apposition tool 218). The actuation mechanism 1514 may drive a linear degree of freedom of motion such as a bi-directional motion of the suture needle (e.g., suture needle 214).

The actuation mechanisms 1506, 1508, 1510, 1512, 1514 may be similar in structure and function to one or more of the actuation mechanisms 804-814 described above and may each include a servomechanism or motor, an actuator housing, gearing or a drive system, and an instrument device connector. An instrument device (e.g. a tissue apposition device, a needle deployment tool, a suture needle) may be removably coupled to and movable by one or more of the actuation mechanisms 1506, 1508, 1510, 1512, 1514.

In various examples, movement of an instrument device such as a tissue apposition tool 1505 may be accomplished with a hybrid system of servo and direct manual controlled degrees of freedom. For example, the tissue apposition tool 1505 may be attached by proximal coupling portions to the set of actuation mechanisms 1506, 1512 that may control certain degrees of freedom of motion of the tissue apposition tool 1505. In this example, the actuation mechanism 1506 may drives a motion of a component of the tissue apposition tool 1505 to cause a grasper jaw opening and closing. The actuation mechanism 1512 may actuate one or more gears or drive systems that rotate the tissue apposition tool 1505. In some examples, the actuation mechanism 1512 may rotate the tissue apposition tool 1505 by a predetermined number of revolutions in response to a rotation initiation action (e.g., a direct manual five degree twist action) of the handle portion 1504 by an operator. As the tissue apposition tool 1505 (e.g. helical tissue apposition tool) is rotated into tissue, haptic cues about the state of the tissue apposition tool may be valuable to the operator. For example, an operator may find it valuable to know if the tissue apposition tool is encountering increased resistance (e.g., indicating the tissue is twisting) or decreased torque (e.g., indicating the tissue apposition tool has exited through a tissue backside). In some examples, the actuation mechanism 1512 may include a current sensor for sensing torque. The current (e.g., corresponding to torque) of the drive servo may be monitored, and the current (e.g., corresponding to torque) of the handle portion 1504 is adjusted accordingly to indicate the torque sensed. Thus, the user receives the haptic sensation or feel of the helix torque at handle portion 1504. The feedback may be used by the operator to determine whether to continue to initiate rotation, terminate rotation, or initiate a reverse rotation.

In this example, an actuation mechanism to drive insertion and retraction motion of the shaft of a tissue apposition tool 1505 may be omitted and this degree of freedom of motion may be actuated manually by an operator. More specifically, an operator may grasp a handle portion 1504 of the local manual user interface device 1502 to advance or retract the tissue apposition tool 1505 (including an instrument carriage 1507 or other movable support structures for the tool 1505). The handle portion 1504 may be coupled to a proximal end of the tissue apposition tool 1505. To improve the user haptics, the carriage 1507 may include a constant force spring to counter gravity.

The handle portion 1504 may also include a trigger mechanism 1509 (e.g. a button, switch, or other binary toggle) that may actuate one or more of the actuation mechanisms 1508, 1510, 1514 in a sequence to, for example, move one or more instrument devices, including a needle deployment tool 1511, involved in creating a suture stitch. The needle deployment tool 1511 may be used to actuate one or more of a needle tip capture mechanism, a needle exchange tool, and a needle. The telescoping components of the needle deployment tool 1511 (e.g., a collet, a needle, and a needle exchange tool) may be assembled and may be installed by first loading a distal end into the endoscope. The needle deployment tool 1511 may include instrument components slidable within and/or otherwise independently movable relative to outer instrument components. Then, as shown in FIG. 18B, proximal coupling portions 1513 of the needle deployment tool 1511 may be coupled to connectors of the instrument actuation apparatus 1500, for example using magnets.

In this example, the actuation mechanism 1508 may cause a pivoting motion of an arm 1549 that drives a linear motion to actuate a portion of the needle deployment tool 1511, such as a needle tip capture mechanism. In some examples, the actuation mechanism 1510 may drive an insertion and retraction motion of the needle deployment tool 1511 (e.g., needle exchange tool 219).

In this example, an operator's interaction with the handle portion 1504 of the local manual user interface device 1502 may control a plurality instrument devices coupled to the instrument actuation apparatus 1500. In this example, the distal platform 1520 may be coupled to a proximal end portion of an instrument system (e.g., instrument system 200 or an endoscope 1450), and the instrument devices actuatable by the instrument actuation apparatus 1500 may extend through the instrument system. In some examples, a proximal portion of the endoscope and the attached instrument actuation apparatus 1500 may be held or supported by one hand of an operator, and a distal portion of the endoscope may be held or supported by the other hand of the operator.

In the description, specific details have been set forth describing some examples. Numerous specific details are set forth to provide a thorough understanding of the examples. It will be apparent, however, to one skilled in the art that some examples may be practiced without some or all these specific details. The specific examples disclosed herein are meant to be illustrative but not limiting. One skilled in the art may realize other elements that, although not specifically described here, are within the scope and the spirit of this disclosure.

Elements described in detail with reference to one example, implementation, or application optionally may be included, whenever practical, in other examples, implementations, or applications in which they are not specifically shown or described. For example, if an element is described in detail with reference to one example and is not described with reference to a second example, the element may nevertheless be claimed as included in the second example. Thus, to avoid unnecessary repetition in the description, one or more elements shown and described in association with one example, implementation, or application may be incorporated into other examples, implementations, or aspects unless specifically described otherwise, unless the one or more elements would make an example or implementation non-functional, or unless two or more of the elements provide conflicting functions. Not all the illustrated processes may be performed in all examples of the disclosed methods. Additionally, one or more processes that are not expressly illustrated in may be included before, after, in between, or as part of the illustrated processes. In some examples, one or more of the processes may be performed by a control system or may be implemented, at least in part, in the form of executable code stored on non-transitory, tangible, machine-readable media that when run by one or more processors may cause the one or more processors to perform one or more of the processes.

Any alterations and further modifications to the described devices, instruments, methods, and any further application of the principles of the present disclosure are fully contemplated as would normally occur to one skilled in the art to which the disclosure relates. In addition, dimensions provided herein are for specific examples and it is contemplated that different sizes, dimensions, and/or ratios may be utilized to implement the concepts of the present disclosure. To avoid needless descriptive repetition, one or more components or actions described in accordance with one illustrative example can be used or omitted as applicable from other illustrative examples. For the sake of brevity, the numerous iterations of these combinations will not be described separately. For simplicity, in some instances the same reference numbers are used throughout the drawings to refer to the same or like parts.

The systems and methods described herein may be suited for imaging and treatment, via natural or surgically created connected passageways, in any of a variety of anatomic systems, including the lung, colon, the intestines, the stomach, the liver, the kidneys and kidney calices, the brain, the heart, the circulatory system including vasculature, and/or the like. While some examples are provided herein with respect to medical procedures, any reference to medical or surgical instruments and medical or surgical methods is non-limiting. For example, the instruments, systems, and methods described herein may be used for non-medical purposes including industrial uses, general robotic uses, and sensing or manipulating non-tissue work pieces. Other example applications involve cosmetic improvements, imaging of human or animal anatomy, gathering data from human or animal anatomy, and training medical or non-medical personnel. Additional example applications include use for procedures on tissue removed from human or animal anatomies (without return to a human or animal anatomy) and performing procedures on human or animal cadavers. Further, these techniques can also be used for surgical and nonsurgical medical treatment or diagnosis procedures.

The methods described herein may be illustrated as a set of operations or processes that may be performed in the same or in a different order than the order shown in the provided flowcharts. One or more of the illustrated processes may be omitted in some examples of the method. Additionally, one or more processes that are not expressly illustrated in the flowchart may be included before, after, in between, or as part of the illustrated processes. In some examples, one or more of the processes of a method may be implemented, at least in part, by a control system executing code stored on non-transitory, tangible, machine-readable media that when run by one or more processors (e.g., the processors of a control system) may cause the one or more processors to perform one or more of the processes.

One or more elements in examples of this disclosure may be implemented in software to execute on a processor of a computer system such as control processing system. When implemented in software, the elements of the examples of this disclosure may be code segments to perform various tasks. The program or code segments can be stored in a processor readable storage medium or device that may have been downloaded by way of a computer data signal embodied in a carrier wave over a transmission medium or a communication link. The processor readable storage device may include any medium that can store information including an optical medium, semiconductor medium, and/or magnetic medium. Processor readable storage device examples include an electronic circuit; a semiconductor device, a semiconductor memory device, a read only memory (ROM), a flash memory, an erasable programmable read only memory (EPROM); a floppy diskette, a CD-ROM, an optical disk, a hard disk, or other storage device. The code segments may be downloaded via computer networks such as the Internet, Intranet, etc. Any of a wide variety of centralized or distributed data processing architectures may be employed. Programmed instructions may be implemented as a number of separate programs or subroutines, or they may be integrated into a number of other aspects of the systems described herein. In some examples, the control system may support wireless communication protocols such as Bluetooth, Infrared Data Association (IrDA), HomeRF, IEEE 802.11, Digital Enhanced Cordless Telecommunications (DECT), ultra-wideband (UWB), ZigBee, and Wireless Telemetry.

Note that the processes and displays presented might not inherently be related to any particular computer or other apparatus. Various general-purpose systems may be used with programs in accordance with the teachings herein, or it may prove convenient to construct a more specialized apparatus to perform the operations described. The required structure for a variety of these systems will appear as elements in the claims. In addition, the examples of the invention are not described with reference to any particular programming language. It will be appreciated that a variety of programming languages may be used to implement the teachings of the invention as described herein.

This disclosure describes various instruments, portions of instruments, and anatomic structures in terms of their state in three-dimensional space. As used herein, the term position refers to the location of an object or a portion of an object in a three-dimensional space (e.g., three degrees of translational freedom along Cartesian x-, y-, and z-coordinates). As used herein, the term orientation refers to the rotational placement of an object or a portion of an object (e.g., in one or more degrees of rotational freedom such as roll, pitch, and/or yaw). As used herein, the term pose refers to the position of an object or a portion of an object in at least one degree of translational freedom and to the orientation of that object or portion of the object in at least one degree of rotational freedom (e.g., up to six total degrees of freedom). As used herein, the term shape refers to a set of poses, positions, or orientations measured along an object.

While certain illustrative examples of the invention have been described and shown in the accompanying drawings, it is to be understood that such examples are merely illustrative of and not restrictive on the broad invention, and that the examples of the invention are not limited to the specific constructions and arrangements shown and described, since various other modifications may occur to those ordinarily skilled in the art.

1. A manual user interface system comprising:
a knob movable in at least one rotational degree of freedom and at least one translational degree of freedom; and
an actuator system coupled to the knob and responsive to a plurality of movements of the knob to operate a plurality of instrument devices of a robotically-assisted instrument system through a plurality of predetermined stages of a sequential workflow.

2. The manual user interface system of claim 1, wherein the knob is movable in opposite directions in the rotational degree of freedom.

3. The manual user interface system of claim 1, wherein the knob is movable in opposite directions in the translational degree of freedom.

4. The manual user interface system of claim 1, wherein the knob is movable in a plurality of translational degrees of freedom.

5. The manual user interface system of claim 1, wherein the knob is movable in a plurality of rotational degrees of freedom.

6. The manual user interface system of claim 1, wherein the at least one rotational degree of freedom or the at least one translational degree of freedom of the knob may be locked based on an instrument device of the plurality of instrument devices currently in operation.

7. The manual user interface system of claim 1, wherein one or more rotational or translational degrees of freedom of the knob may be locked based on a current stage of the sequential workflow.

8. The manual user interface system of claim 1, wherein the knob includes a force sensor responsive to a squeeze action.

9. The manual user interface system of claim 1, wherein the knob includes a touch screen.

10. The manual user interface system of claim 1, wherein the knob is configured to provide a haptic output.

11. The manual user interface system of claim 1, further comprising a panel to which the knob is mounted, wherein at least one of a second knob or a touchscreen is mounted to the panel.

12-14. (canceled)

15. A manual user interface system comprising:
a knob movable in at least one rotational degree of freedom; and
an actuator system coupled to the knob and responsive to rotation of the knob in a first direction of the rotational degree of freedom to operate a device of a robotically-assisted instrument system through a forward sequence of stages of a workflow and responsive to rotation of the knob in a second direction of the rotational degree of freedom to operate the device through a reverse sequence of stages of the workflow.

16. The manual user interface system of claim 15, wherein the knob is movable in a plurality of rotational degrees of freedom.

17. The manual user interface system of claim 15, wherein the knob is movable in opposite directions in the at least one rotational degree of freedom.

18. The manual user interface system of claim 15, wherein the at least one rotational degree of freedom of the knob may be locked based on the device of the robotically-assisted instrument system currently in operation.

19. The manual user interface system of claim 15, wherein the at least one rotational degree of freedom of the knob may be locked based on a current stage of the workflow.

20. The manual user interface system of claim 15, wherein the knob includes a force sensor responsive to a squeeze action.

21. The manual user interface system of claim 15, wherein the knob includes a touch screen.

22. The manual user interface system of claim 15, wherein the knob is configured to provide a haptic output.

23. The manual user interface system of claim 15, further comprising a panel to which the knob is mounted, wherein at least one of a second knob or a touchscreen is mounted to the panel.

24-53. (canceled)
